(19) United States
(12) Patent Application Publication
(10) Pub. No.: US 2025/0315881 A1
(43) Pub. Date: Oct. 9, 2025

(54) SYSTEMS, DEVICES, ARTICLES, AND METHODS TO PROVIDE A CUSTOMIZED RETAIL EXPERIENCE

(71) Applicant: LULULEMON ATHLETICA CANADA INC., Vancouver (CA)

(72) Inventors: Ellisa Kathleen CALDER, Vancouver (CA); Michelle Lee STAVER, Vancouver (CA); Mallory Michelle CHAPMAN, Vancouver (CA); Samuel Haskel BERGMANN-GOOD, Vancouver (CA)

(21) Appl. No.: 18/866,003

(22) PCT Filed: May 26, 2023
(86) PCT No.: PCT/CA2023/050723

§ 371 Date: Nov. 14, 2024

Related U.S. Application Data
(60) Provisional application No. 63/346,684, filed on May 27, 2022.

(51) Int. Cl. G06Q 30/0601; G06Q 50/00

(52) U.S. Cl. CPC G06Q 30/0643; G06Q 30/0603; G06Q 30/0621; G06Q 50/01

(57) ABSTRACT

Embodiments described herein relate to systems, devices, articles, and methods for an affiliate, a first user, to define interaction experience model for a second user, a guest, such as, a retail experience based on approved plurality of items, and share that interaction experience with the second user.

### TECHNICAL FIELD

The present disclosure relates to electrical computers, digital processing, computer interfaces, retail systems, smart devices, digital classes and environments, monitoring the health of individuals including physiological states, psychological, and emotional wellness, processor generated environments, machine learning, digital simulation, and systems integrations.

### INTRODUCTION

Web sites define in process-executable instruction and/or processor readable-data which when executed by processor-based devices provide information to market items and controls allowing users to purchase goods. However, providing web-based or electronic retail experiences come with technical challenges and computer problems.

A social network defines or improves a community. Connections can be made or maintained in person or virtually. Providing a social network, includes maintaining processor-based devices and processor-executable instructions and/or processor-readable data which provides the graphical user interfaces for communication, electronic records of individuals, and electronic records of their activities. The electronic records for example, could be stored in database containing a plurality of records for individuals including attributes of the individual, their connections, messages, history, and so on.

### SUMMARY

In an aspect, there is provided a system for an interaction experience model defined in processor-executable instructions. The system has: at least one controller that performs measurements or operations relating to items or the first user. The system has a first user device of a plurality of user devices, wherein the first user device comprises a client processor that identifies a plurality of items approved by the first user from the measurements or operations. The system has at least one processor communicatively coupled to the first user device; and at least one non-transitory processor-readable storage device communicatively coupled to the at least one processor and which stores processor-executable system instructions including an interface that receives the plurality of items approved by the first user device.

The processor: generates a first interaction experience model defined in processor-executable instructions based on the plurality of items approved by the first user device; stores the first interaction experience model in the at least one non-transitory processor-readable storage device; generates an instance of an interaction experience of the first interaction experience model defined in processor-executable instructions by accessing the at least one non-transitory processor-readable storage device; executes the interaction experience model defined in processor-executable instructions to cause a display screen to display the instance of the first interaction experience model.

In some embodiments, the system has at least one sensor that performs a portion of the measurements or operations relating to items or the first user, wherein the processor generates the first interaction experience model at least in part using the measurements.

In some embodiments, the interaction experience comprises a visual interaction experience, wherein the processor generates one or more visual elements of the visual interaction experience, and wherein the display device executes the interaction experience model defined in processor-executable instructions to display of the one or more visual elements as part of the interaction experience.

In some embodiments, the interaction experience comprises at least one of a visual interaction experience, an audio interaction experience, and a tactile interaction experience.

In some embodiments, the at least one processor receives from the first user device, a first affiliate identifier associated with the first user.

In some embodiments, the interaction experience comprises a fit surrogate interaction experience model. In some embodiments, the at least one processor: identifies one or more shared physical characteristics associated with a first affiliate and the first user; identifies one or more shared gender identities associated with a first affiliate and the first user; generates the fit surrogate interaction experience model using the shared one or more physical characteristics, the one or more shared gender identities, and affiliate data associated with the first affiliate.

In some embodiments, the at least one processor links a first community identifier associated with the first interaction experience model.

In some embodiments, the at least one processor generates the first community identifier based on one or more of: an activity, a location, a device type, a social network record, a second community identifier, a first affiliate identifier associated with the first user, or a second affiliate identifier associated with one or more further affiliates.

In some embodiments, the at least one processor generates a link to access a server providing a first interaction experience based on the first interaction experience model.

In some embodiments, the at least one processor distributes the link to access the server providing the first interaction experience based on the first interaction experience model.

In some embodiments, the system has a second user device associated with a second user in communication with the at least one processor. In some embodiments, the at least one processor: distributes the link to access the server providing the first interaction experience based on the first interaction experience model to the second user device associated with the second user second.

In some embodiments, the plurality of items includes a respective item; and the at least one processor generates the link to access the server providing the first interaction experience based on the first interaction experience model, wherein the link features the respective item.

In some embodiments, the at least one processor: receives an interaction experience customization selected by the first user; and generates a second interaction experience model based on the plurality of items and the set of customization selected by the first user.

In some embodiments, the interaction experience customization selected by the first user; is selected from the group comprising: item customization, esthetic customization, behavior customization, assistance customization, and rewards customization.

In some embodiments, the at least one processor: receives a selection, by the first user, of a template for an interaction experience; and generates the first interaction experience model based on the plurality of items and the template for an interaction experience.

In some embodiments, the interaction experience is a retail experience, and the plurality of items are goods and services for sale from a merchant.

In some embodiments, the interaction experience is a social network experience and the plurality of items are goods and services used in a social network.

In some embodiments, the at least one processor receives one or more of affiliate data, user data, community data, and retail data, and updates the interaction experience model using the one or more of affiliate data, user data, community data, and retail data.

In some embodiments, there is provided a computer implemented method of operation in an interaction system comprising a least one processor, at least one non-transitory processor-readable storage medium communicatively coupled to the at least one processor, and a first user device associated with a first user in communication with the at least one processor. The method involves: performing measurements or operations relating to items or the first user using at least one controller; receiving, by the at least one processor from the first user device, a plurality of items approved by the first user in part based on the measurements or operations relating to the items or the first user performed using the at least one controller; generating, by the at least one processor, a first interaction experience model defined in processor-executable instructions based on the plurality of items approved by the first user; storing, by the at least one processor on the at least one non-transitory processor-readable storage medium, the first interaction experience model; and generating an instance of an interaction experience of the first interaction experience model defined in processor-executable instructions by accessing the at least one non-transitory processor-readable storage medium; and executing the interaction experience model defined in processor-executable instructions to cause a display screen to display the instance of the interaction experience of the first interaction experience model.

In some embodiments, the method involves performing a portion of the measurements or operations relating to items or the first user using at least one sensor, and generating, by the at least one processor, the first interaction experience model at least in part using the measurements.

In some embodiments, the interaction experience comprises a visual interaction experience, wherein the method further comprises generating one or more visual elements of the visual interaction experience, and executing the interaction experience model defined in processor-executable instructions to cause the display of the one or more visual elements as part of the interaction experience.

In some embodiments, the interaction experience comprises at least one of a visual interaction experience, an audio interaction experience, and a tactile interaction experience.

In some embodiments, the method involves: receiving, by the at least one processor from the first user device, a first affiliate identifier associated with the first user.

In some embodiments, the interaction experience comprises a fit surrogate interaction experience model. The method involves identifying one or more shared physical characteristics associated with a first affiliate and the first user; identifying one or more shared gender identities associated with a first affiliate and the first user; and generating the fit surrogate interaction experience model using the shared one or more physical characteristics, the one or more shared gender identities, and affiliate data associated with the first affiliate.

In some embodiments, there is provided a non-transitory computer readable medium storing instructions executable by at least one processor, to cause the at least one processor to implement operations comprising: performing measurements or operations relating to items or the first user using at least one controller; receiving, by the at least one processor from the first user device, a plurality of items approved by the first user in part based on the measurements or operations relating to the items or the first user performed using the at least one controller; generating, by the at least one processor, a first interaction experience model defined in processor-executable instructions based on the plurality of items approved by the first user; storing, by the at least one processor on the at least one non-transitory processor-readable storage medium, the first interaction experience model; and generating an instance of an interaction experience of the first interaction experience model defined in processor-executable instructions by accessing the at least one non-transitory processor-readable storage medium; and executing the interaction experience model defined in processor-executable instructions to cause a display screen to display the instance of the interaction experience of the first interaction experience model.

In some embodiments, the at least one processor executes the instructions to trigger performing a portion of the measurements or operations relating to items or the first user using at least one sensor, and generating, by the at least one processor, the first interaction experience model at least in part using the measurements.

In some embodiments, the interaction experience comprises a visual interaction experience, wherein the at least one processor executes the instructions to trigger generating one or more visual elements of the visual interaction experience, and executing the interaction experience model defined in processor-executable instructions to cause the display of the one or more visual elements as part of the interaction experience.

In some embodiments, the interaction experience comprises at least one of a visual interaction experience, an audio interaction experience, and a tactile interaction experience.

In some embodiments, the at least one processor executes the instructions to trigger receiving, from the first user device, a first affiliate identifier associated with the first user.

In some embodiments, the interaction experience comprises a fit surrogate interaction experience model, and the at least one processor executes the instructions to trigger identifying one or more shared physical characteristics associated with a first affiliate and the first user; identifying one or more shared gender identities associated with a first affiliate and the first user; and generating the fit surrogate interaction experience model using the shared one or more physical characteristics, the one or more shared gender identities, and affiliate data associated with the first affiliate.

In an aspect, there is provided a computer implemented method of operation in an interaction system including a least one processor, at least one non-transitory processor-readable storage medium communicatively coupled to the at least one processor, and a first user device associated with a first user in communication with the at least one processor. The method includes performing measurements or operations relating to items or the first user using at least one controller or sensor, and receiving, by the at least one processor from the first user device, a plurality of items approved by the first user in part based on the measurements or operations relating to items or the first user using the at least one controller and sensor. The method includes generating, by the at least one processor, a first interaction experience model based on the plurality of items, and storing, by the at least one processor on the at least one non-transitory processor-readable storage medium, the first interaction experience model. The method includes generating an instance of the interaction experience based on the first interaction experience model defined in processor-executable instructions which, when executed by the client processor causes the first user device to display the instance of the first interaction experience model.

In another aspect there is provided, a method of operation in an interaction system including a least one processor, at least one non-transitory processor-readable storage medium communicatively coupled to the at least one processor, and a first user device associated with a first user in communication with the at least one processor. The method includes receiving, by the at least one processor from the first user device, a plurality of items approved by the first user, and generating, by the at least one processor, a first interaction experience model based on the plurality of items. The method further includes storing, by the at least one processor on the at least one non-transitory processor-readable storage medium, the first interaction experience model.

In another aspect, there is provided a system including a first user device of a plurality of user devices. The first user device includes a client processor that identifies a plurality of items approved by the first user from measurements or operations relating to items or the first user generated by at least one controller or sensor. The first user device has a transceiver for transmitting the plurality of items approved by the first user, and receiving commands to present an instance of an interaction experience. The system includes at least one processor communicatively coupled to the first user device, and at least one non-transitory processor-readable storage device communicatively coupled to the at least one processor and which stores processor-executable system instructions including an interface that receives the plurality of items approved by the first user device. The processor generates a first interaction experience model based on the plurality of items approved by the first user device, and generates the instance of the interaction experience based on the first interaction experience model defined in processor-executable instructions which, when executed by the client processor causes the client processor of the first user device to present the instance of the first interaction experience model.

In another aspect, there is provided a system including at least one sensor or controller that performs measurements or operations relating to items or the first user, and a first user device of a plurality of user devices. The first user device includes a client processor that identifies a plurality of items approved by the first user from the measurements or operations. The system includes at least one processor communicatively coupled to the first user device, and at least one non-transitory processor-readable storage device communicatively coupled to the at least one processor and which stores processor-executable system instructions including an interface that receives the plurality of items approved by the first user device. The processor generates a first interaction experience model based on the plurality of items approved by the first user device, and generates the instance of the interaction experience based on the first interaction experience model defined in processor-executable instructions which, when executed by the client processor causes the client processor of the first user device to present the instance of the first interaction experience model.

In another aspect, there is provided a system including a plurality of user devices including a first user device. A respective user device in the plurality of user devices includes a client processor. The system also including at least one processor communicatively coupled to the first user device, and at least one non-transitory processor-readable storage device communicatively coupled to the at least one processor and which stores processor-executable system instructions. The processor-executable system instructions when executed by the at least one processor, cause the at least one processor to receive a plurality of items approved by a first user, and generate a first interaction experience model based on the plurality of items approved by the first user. The processor-executable system instructions when executed by the at least one processor, further cause the at least one processor to generate an instance of the interaction experience based on the first interaction experience model defined in processor-executable instructions which, when executed by the client processor causes the client processor to present the instance of the first interaction experience model.

In a further aspect, there is provided a method of operation in an interaction system including a least one processor communicatively coupled to a plurality of user devices. The method including receiving, by the at least one processor from a first respective user device in the plurality of devices, a request for an interaction experience, and generating, by the at least one processor, a first instance of the interaction experience based on the first interaction experience model. The interaction experience is based on a first interaction experience model including a plurality of items approved by an affiliate.

In another aspect, there is provided a system including a plurality of user devices, and at least one processor communicatively coupled to the plurality of user devices. A respective user device in the plurality of user devices includes a client processor. The system further includes at least one non-transitory processor-readable storage device communicatively coupled to the at least one processor and which stores processor-executable instructions and processor-readable data. The processor-readable data defines a first interaction experience model including a plurality of items approved by a first user associated with a first user device in the plurality of user devices. The processor-executable instructions which, when executed by the at least one processor, cause the at least one processor to receive a request for an interaction experience based on the first interaction experience model, and generate a first instance of the interaction experience based on the first interaction experience model.

In a further aspect, there is provided a method of operation in an interaction system including a least one processor, at least one non-transitory processor-readable storage medium communicatively coupled to the at least one processor, a network interface communicatively coupled to the at least one processor which provides communication with a plurality of user devices. The method includes generating, by the at least one processor, a user interface to be rendered on a respective user device in the plurality of user devices. The user interface includes a plurality of items. The method includes generating, by the at least one processor, an interaction experience that features the plurality of items. The method further includes receiving, by the at least one processor, an affiliate enrollment from a first user that select and recommend items from the plurality of items, and assigning, by the at least one processor, an affiliate identifier to the first user. The method further includes providing, by the at least one processor, a link associated the affiliate identifier that, when selected by a second user at the user device causes a respective user device in the plurality user devices to provide an instance of the interaction experience, and recording, by the at least one processor in the non-transitory processor-readable storage medium, record of the provision of an instance of the interaction experience associated with the affiliate.

This summary does not necessarily describe the entire scope of all aspects. Other aspects, features and advantages will be apparent upon review of the following description of specific embodiments.

### BRIEF DESCRIPTION OF THE DRAWINGS

Systems, devices, articles, and methods are described in greater detail herein with reference to the following figures in which:

FIG. 1 is a schematic diagram illustrating a portion of a system including at least one server and one user device;

FIG. 2 is a schematic diagram illustrating a portion of a system including at least two servers;

FIG. 3 is a schematic diagram illustrating a portion of a system including a plurality of individuals segmented into a plurality of communities and interacting with at least one server;

FIG. 4A and FIG. 4B are schematic diagrams illustrating a plurality of possible workflows an affiliate may follow to provide an approved plurality of items, and customize an interaction experience;

FIG. 5 is a flow-diagram illustrating an implementation of a method of operation for an interaction system;

FIG. 6 is a flow-diagram illustrating an implementation of a method of operation for an interaction system;

FIG. 7 is a flow-diagram illustrating an implementation of a method of operation for an interaction system;

FIG. 8 is a flow-diagram illustrating an implementation of a method of operation for an interaction system in communication with a user;

FIG. 9 is a flow-diagram illustrating an implementation of a method of operation for an interaction system in communication with a user; and

FIG. 10 is a flow-diagram illustrating, from the perspective of a user, an implementation of a method of operation for an interaction system in communication with the user.

In the drawings, the same reference numbers identify similar elements or acts. In the drawings, angle, size, and relative position of elements are not necessarily shown to scale. For example, some of these elements may be enlarged or positioned to improve drawing legibility. Further, the shapes of any elements as drawn, are not necessarily intended to convey any information regarding the actual shape of the particular elements and may have been solely selected for ease of illustration or recognition.

### DETAILED DESCRIPTION

Embodiments of systems, devices, articles, and methods described herein may be described with reference to three entities: a host, a guest and an affiliate. The host, a first entity, controls an interaction experience. For example, the host can be a seller, vendor, or merchant like an individual, company, or partnership that offers products or items—e.g. goods or services. Goods can include tangible items such as apparel (e.g. shoes, garments, accessories), equipment, and other types of items such as credit, digital goods, tokens, or vouchers. Services can include classes, events (e.g. meet-up, retreat), memberships, and the like. The guest, a second entity, is a participant that interacts with the host. For example, in a retail experience, the guest at least considers purchasing one or more items from the host, a merchant. Often the guest is a purchaser of the one or more items from the host. The affiliate, a third entity, alters the behaviour of the guest or host. The affiliate, also called an influencer or partner, can have a relationship with both the host and the guest and can provide recommendations and opportunities to purchase items from the host. Note there may be one or more of each of the host, guest, or affiliate. An entity, such as a person, can hold one role or two roles, like being both a guest and affiliate.

The entities can interact in different environments or settings. For example, the guest can follow the affiliate on a social network or attend a tangible location to interact with the host. As well, the guest and affiliate can interact in a processor generated environment (PGE) (e.g. augmented reality, virtual reality), such as, an online exercise class, or online class with augmented content. This PGE could contain at least the starting point of an interaction experience, such as a retail experience.

The present disclosure involves systems, devices, articles, and methods which in operation define or implement one or more instances of one or more interaction experiences. A first user, an affiliate, defines the one or more interaction experiences. An interaction experience model can be defined in processor-executable code. An interaction experience model includes objects in an application defined by processor-executable code and provides (or is used to generate) the one or more instances of the interaction experience for a second user, a guest (e.g. potential customer or customer). An example of an interaction experience model is executable code for a curated retail experience. A model can be a simplified or idealized encoded description of a particular system, situation, or process that can be embodied in structured terms, processor-readable data, or processor-executable instructions used as a basis for theoretical or empirical understanding, or for operations of a processor-based device, such as, calculations, predictions, and materialization. For example, a model can be computer program product or code representations of commands, rules, procedures, processes, data structures, or assemblies thereof to generate instances of interaction experiences. An example interaction experience is a visual experience using one or more display devices. Other examples include an audio experience, tactile experience, and so on. Accordingly, in some embodiments, the interaction experience is a visual interaction experience. The system 200 can generate one or more visual elements of the visual interaction experience as part of the interaction experience. The system 200 can trigger execution of the interaction experience model defined in processor-executable instructions to cause the display of the one or more visual elements as part of the interaction experience, or other type of provision of the interaction experience (e.g. audio elements, tactile elements).

In some embodiments, the first user defines an interaction experience which is a social network experience. In this way the first user creates and sustains a community where being physically present in the same location is not always possible. The first user may define a curated or gated experience on a social network. A social network experience can include access to specific content, membership in a group, communication amongst group members, acts of expression by group members, and the like. A social network experience can include classes like one off events, informal sessions, product education, or courses including a defined cohort, one or more events, curriculum, graded achievement, and certification. The host supports these activities with various benefits including generation of community, transfer of content creation to community, provision of content that guests care about, empower affiliates in creating content for guests, allow guests to be become affiliates, and the like.

In some embodiments, the interaction experience is a mix of social network experience and retail experience. The first user can generate content that espouses benefits of a good, why they like the good, or a combination of good, e.g. outfit. The first user may generate content such as a sneak peak or drop (e.g. early opportunity to purchase) of an item. A social network experience can include items that a second user purchases, including a zero-payment purchase, such as badges, overlays, pre-sets, and templates. In some embodiments, the second user moves from a social network experience to a retail experience; or the reverse. For example, a first user can be a member of a community that practices meditation and yoga. The first user could have an enduring retail experience that also promotes special events, such as, a meditation month during which the first user leads meditation. Also considering the first user could define an enduring social network experience but, with the host, offer a time limited or ancillary retail experience.

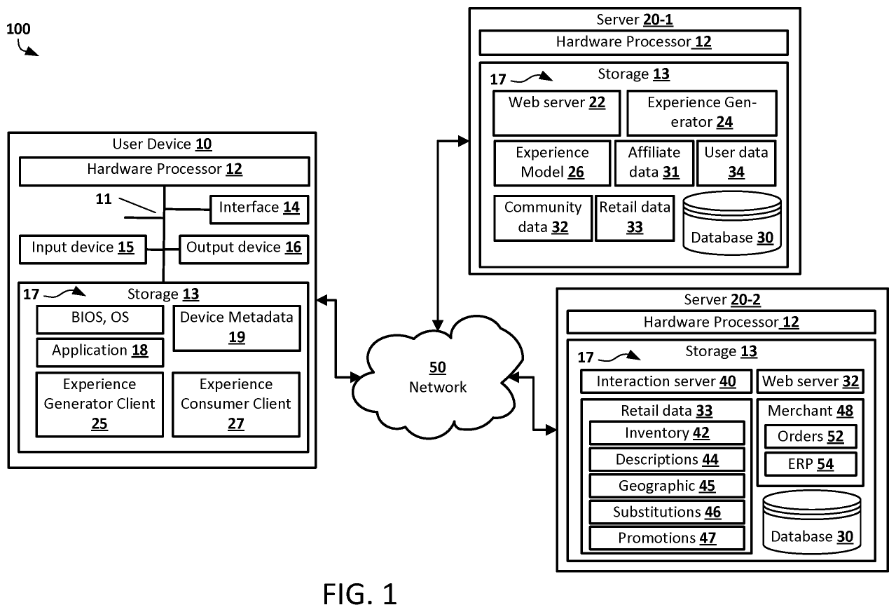

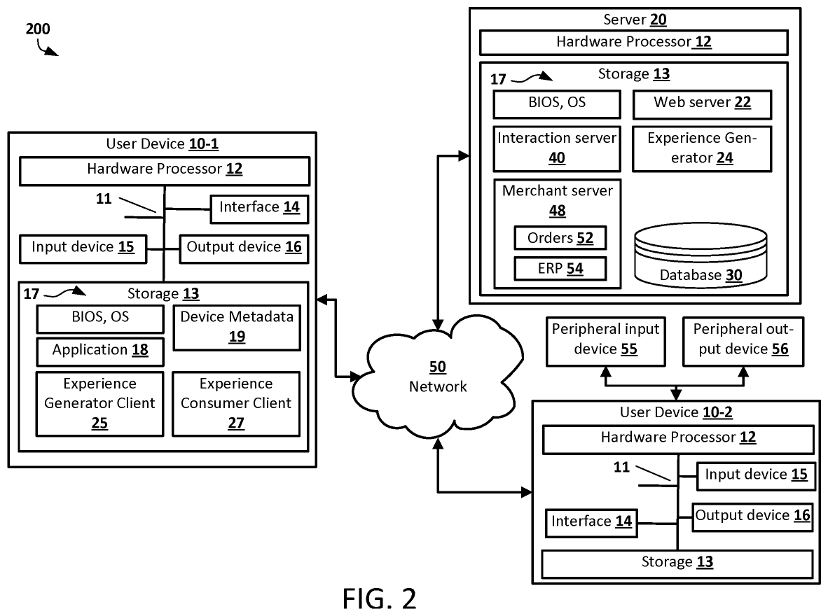

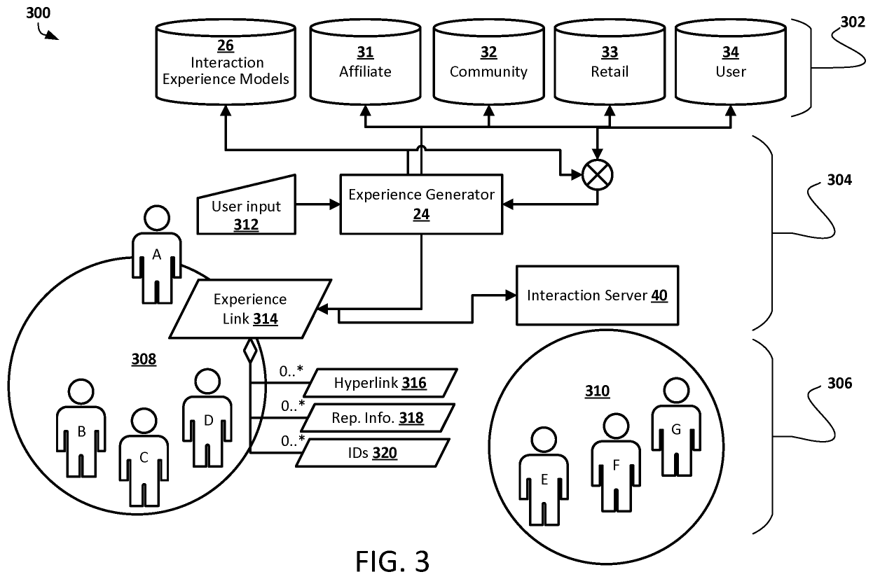

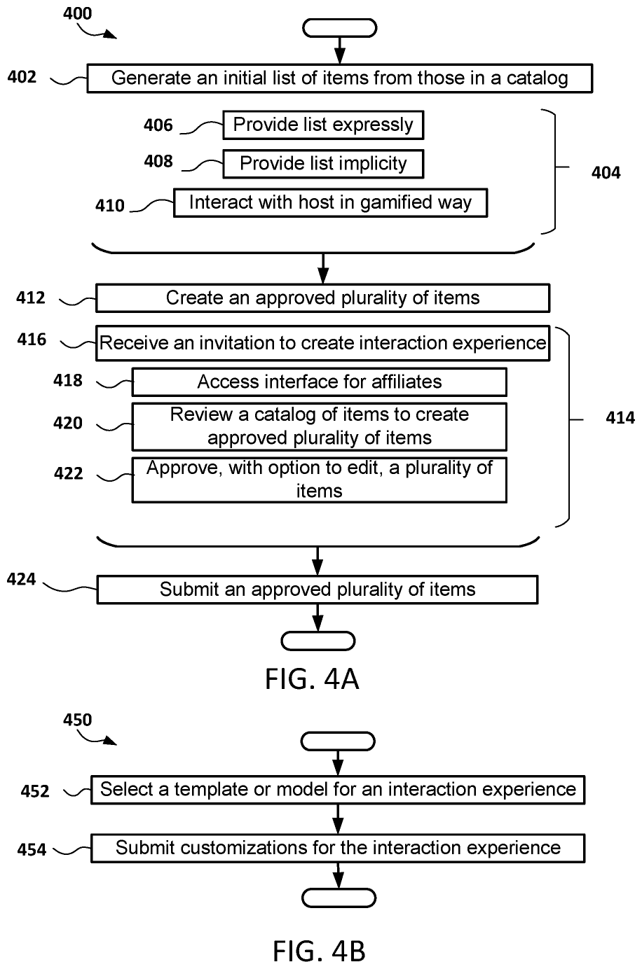

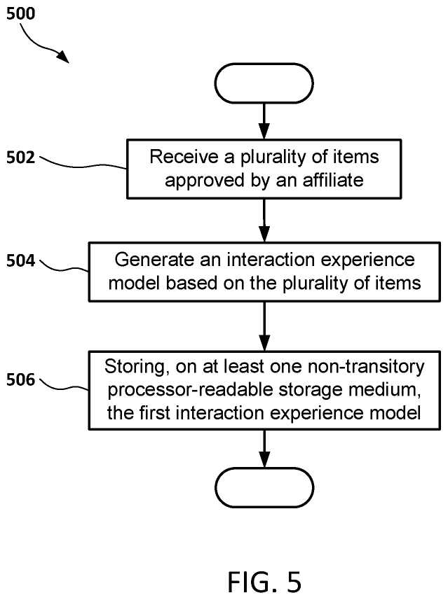

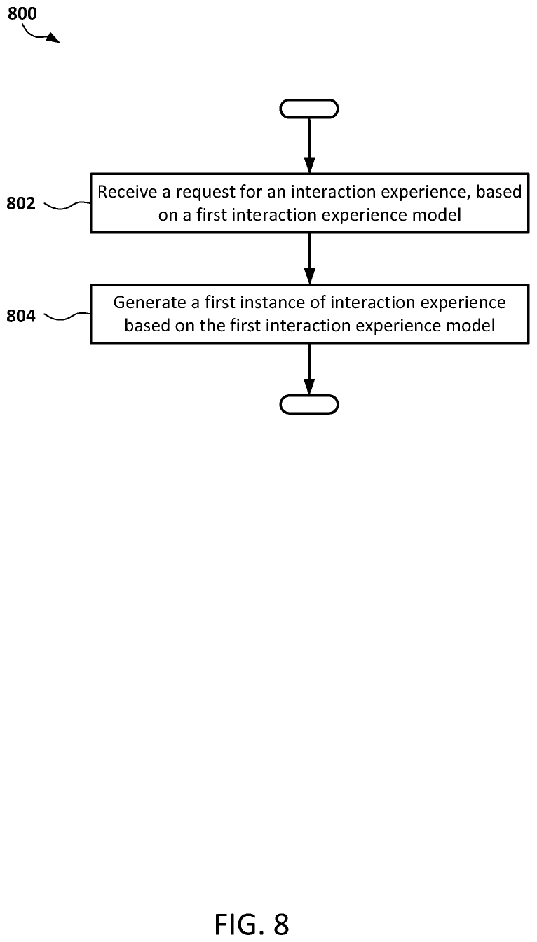

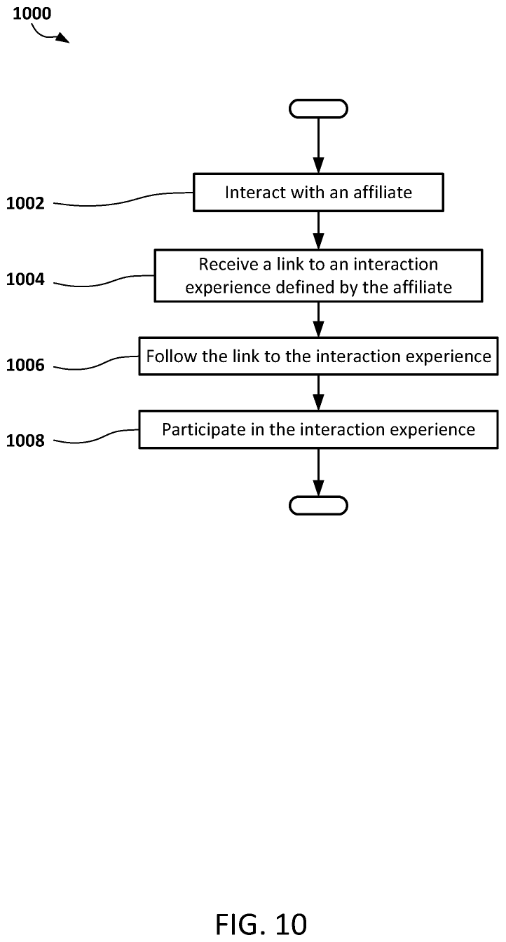

Referring to the drawings, FIG. 1 includes a user device associated with an affiliate and at least one server. FIG. 1 may be associated with an interaction experience. In some embodiments, FIG. 2 includes a user device associated with a guest. FIG. 2 may be associated the provision (e.g. refine, select, provide, or manage) of an interaction experience. FIG. 3 illustrates a schematic diagram including a plurality of individuals segmented into a plurality of communities. FIGS. 4A, 4B illustrates workflows a first user, such as an affiliate, can take, in part, to define an interaction experience for a second user. FIGS. 5, 6, 7, 8, 9, and 10 illustrate exemplary methods of operation for interaction systems, such as, those shown in FIG. 1, 2, or 3. FIGS. 4, 5, 6, and 7 includes methods associated with definition (e.g. define, refine, update) of an interaction experience. FIGS. 8, 9, and 10 are flow-diagrams illustrating implementations of methods of operation for an interaction system in communication with a second user, like a customer, including generating an instance of interaction experience based on a model of the interaction experience. As shown in FIG. 10, the second user may participate in and move between one or more social network experiences or retail experiences as defined by one or more affiliates (e.g. first user).

Turning to FIG. 1 which shows an exemplary interaction system 100 in accordance with the systems, devices, articles, and methods of embodiments described herein. System 100 is an example of a system that operates to define and store an interaction experience in response to input from an affiliate. Various components of interaction system 100 are optional, or may be present in a plurality according to various embodiments described herein. Interaction system 100 includes user device 10, at least one server 20, databases 30 on non-transitory storage devices, and a network 50 communicatively coupled to user device 10 and at least one server 20. User devices 10 and at least one server 20 are processor-based devices that include at least one hardware processor 12.

User device 10 includes hardware processor 12 communicatively coupled to and operable to access a storage device 13. User device 10 further includes a bus 11 communicatively coupled to processor 12 and storage device 13. Bus 11, in some embodiments, couples processor 12 to network interface subsystem 14, input device 15, or output device 16. In some embodiments, user device 10 includes one or more of network interface subsystem 14, input device 15, or output device 16, including a plurality of each device or sub-system.

The processor 12 is at least one processor or a plurality of processors. Processor 12 may be any logic processing unit, such as one or more central processing units (CPUs), cores in processors, application-specific integrated circuits (ASICs), digital processors, digital signal processors (DSPs), graphics processing units (GPUs), microprocessors, network processors (NPs), programmable gate arrays (PGAs), programmed logic units (PLUS), or the like.

Network interface subsystem 14 comprises communication circuitry to support bidirectional communication of processor-readable data, or processor-executable instructions between a first component (e.g. user device 10) and one or more other components in system 100. Network interface subsystem 14 may employ communication protocols (e.g. FTP, HTTPS, SSH, TCP/IP, SOAP plus XML) to exchange processor- readable data, or processor-executable instructions over network 50 (e.g. ETHERNET®, Internet, LAN, WAN) or non-network communication channel (not shown), such as, a serial connection, a parallel connection, wireless connection (e.g. BLUETOOTH® (IEEE 802.15.1), WIFI® (IEEE 802.11), near-field communication), fiber optic connection, combinations of the preceding, or the like.

In some embodiments, at least one server 20 is communicatively coupled to user devices 10 through network 50. Thus, processor-executable instructions or processor-readable data may be transferred between user device 10 and at least one server 20 through network 50, or stored on memory accessible through network 50.

The storage device 13 is a concrete non-transitory hardware component comprising at least one non-transitory processor-readable storage medium including volatile memory or non-volatile memory data storage elements, or a combination thereof. Storage device 13 includes or stores processor-executable instructions and/or processor-readable data 17 associated with the operation of system 100. Execution of processor-executable instructions and/or processor-readable data 17 causes a processor, such as processor 12, to carry out various methods and actions, for example, by network interface subsystem 14, user device 10, at least one server 20, or the like. Processor-executable instructions and/or processor-readable data 17 can, for example, include a basic input/output system (BIOS), an operating system (OS), peripheral drivers (not shown), user device application 18, device metadata 19, experience generator client 25, and experience consumer client 27.

User device application 18 may be a web browser, specific function application (e.g. app, smart phone application), applet, or the like. User device application 18 may be processor-executable instructions designed to perform a specific function other than one relating to the operation of the user device 10. In some embodiments, user device application 18 is a social network client for interacting with a social network service provided by server(s) 20. In some embodiments, user device application 18 may be selected by a first user to define an interaction experience. In some embodiments, the first user, e.g., an affiliate, selects user device application 18 for a different purpose, e.g., social network client.

In some embodiments, device metadata 19 includes information associated with the user device 10 or a user of user device 10. The information associated with the user device 10 may include OS, device capacity (e.g. memory, processor speed), input and output subsystem or peripheral devices (e.g. touch screen, screen resolution, camera resolution, video camera, haptic displays, haptic input, augmented reality glasses, virtual reality headsets), or the like.

The user associated with user device 10 may be a guest, an affiliate, or both. The user may be a guest, such as, participant in a community, user of a service, and customer to a merchant. The user may be an affiliate to a host (e.g. merchant, provider of a service), such as, established customer to a merchant, leader in a community, or the like. In some embodiments, device metadata 19 includes processor-readable data associated with the user of user device 10 selected from a group comprising unique ID, age, age range, gender, activity, activity history, one or more communities, language, location or region, membership level, membership history, purchase history, navigational history, or the like.

The experience generator client 25, and the experience consumer client 27 are clients including processor-executable instructions which when executed by processor 12 cause user device 10 to access data or services provided and managed centrally by another processor-based device like a server, e.g., at least one server 20, to create and consume an interaction experience. In some embodiments, one or both of experience generator client 25, and experience consumer client 27 are part of user device application 18. In some embodiments, the referent experience for experience generator client 25 and experience consumer client 27 is an interaction experience. The interaction experience may be a retail experience.

In some embodiments, a plurality of users participates in interaction system 100 each through an associated (e.g. own, shared) user devices 10 to exchange processor-executable instructions or processor-readable data with at least one server 20 in manners described further herein. For simplicity of illustration, only one user device 10 and two servers 20 are shown in FIG. 1, however, an interaction experience system can include a plurality of user devices. See, for example, FIG. 2. The interaction system 100 is not limited to a particular configuration and different combinations of components can be used for different embodiments. For example, servers or user devices could form a peer-to-peer network where the aggregate of connections forms a communicative coupling. Furthermore, while interaction system 100 shows two servers 20 and two databases 30 as an illustrative example, interaction system 100 extends to different numbers and arrangements of servers 20 and databases 30 (such as a single server communicatively coupled to a single database). The servers 20 can be the same or different types of devices.

According to some embodiments, user device 10 is a mobile device such as a smartphone, although in other embodiments user device 10 may be any other suitable device that may be operated and interfaced with by a user. For example, user device 10 may comprise a laptop, a personal computer, an interactive kiosk, a smart mirror, a wearable device (e.g. smart watch), a tablet device, or the like. User device 10, may include multiple types of user devices and may include a combination of devices within interaction system 100. In some embodiments, user device 10 includes one or more input device 15 or one or more output device 16. The input device 15 can include a sensor or controller that can perform measurements or operations relating to items or users. These measurements or operations can be used to define or identify items that are approved by users, for example. Items that are approved by a user can be used to generate interaction experience models. A controller can be an electronic device (e.g. as part of a control system) that generates control signals as output to control actions of the device or another device. For example, a controller can generate control signals with code that controls operations of a processor or peripheral device, actuate components of a device, and so on. A controller can be a chip, card, an application, or hardware device. A controller can manage and connect devices, or direct the flow of data between devices to provide an interface and manage communication. For example, a controller can be an interface component between a central processing unit and a device being controlled. A controller can be a type of input device that generates and transmits control commands to control operations of a computer, a component, or other device. There are different types of controllers. Controllers automatically control products, embedded systems, and devices using control commands. A controller can have one or more processors, memory and programmable input/output peripherals. A sensor can be an device that detects or measures a physical property, records the detections or measurements, or transmits the detections or measurements. A sensor is a device that responds to a physical stimulus and generates a resulting measurement. A sensor can be a device, machine, or subsystem that detects events or changes in its environment, produces an output signal associated with sensing physical properties, and sends the information to other electronics, such as a hardware processor. Examples of sensors and controllers are disclosed herein in reference to, at least, input devices disclosed in FIGS. 2 and 3. The output device 16 can present an instance of an interaction experience that is generated based on the first interaction experience model. This can be defined in processor-executable instructions which, when executed by the client processor causes the output device 16 to display the instance of the interaction experience of the first interaction experience model.

The exemplary interaction system 100 shown in FIG. 1 includes at least one server 20 and as illustrated server 20-1 and server 20-2. The at least one server 20 provides, receives, and manages data and services for other components of interaction system 100, such as, user device 10 and another server (e.g. server 20-1 with respect to server 20-2). In some embodiments, server 20-1 stores processor executable instructions, which when run, define and generate an interaction experience, such as a curated experience with a merchant. In some embodiments, the interaction experience is defined by processor-readable data included in an interaction experience model. An interaction experience model or an instance of the interaction experience may be based on another interaction experience model, a plurality of approved items, customizations, or data about or from one or more of affiliate, user, community, or host. In some embodiments, server 20-2 includes processor executable instructions, which when run, refine, select, provide, or manage an interaction experience, such as a retail experience, and processor executable instructions to provide a retail experience complete with considerations of interfaces, inventory, logistics, or the like.

The at least one server 20 includes hardware processor 12 communicatively coupled to and operable to access a non-transitory storage device 13 and database 30 by a bus or buses (not shown). In some embodiments, the bus(es) couple processor 12 to network interface subsystem, input subsystem, or output subsystem (all not shown).

Storage device 13 includes or stores processor-executable instructions and/or processor-readable data 17 associated with the operation and control of interaction system 100. Execution of processor-executable instructions and/or processor-readable data 17 causes processor 12 or the at least one server 20 to carry out various methods and actions. Processor-executable instructions and/or processor-readable data 17 can, for example, include BIOS, OS, peripheral drivers (all not shown), a web server 22, experience generator 24, experience model 26, or the like. In some embodiments, processor-executable instructions and/or processor-readable data 17 includes processor-readable data used in the operation of interaction system 100 and may be arranged in a plurality of data sets like affiliate data 31, community data 32, retail data 33, and user data 34.

In some embodiments, interaction system 100 includes one or more databases. Server 20-1 may implement database 30. Storage device 13 may include processor-executable instructions and/or processor-readable data which when executed by a processor implements database 30. At least one server 20 may store data located in databases 30 within memory or disk. However, in some embodiments, servers 20 include processor-executable instructions which when executed access, modify, or write data on a remotely located database.

The web server 22 includes processor-executable instructions or processor-readable data which when executed cause server 20-1 to provide processor-executable instructions or processor-readable data by network 50, other channels, or networks. In some embodiments, web server 22 receives requests by a protocol (e.g. HTTP(S)) for one or more resources and responds with the content of that one or more resources or ancillary messages such as an error message. The content maybe provided in a document model and encoded in a markup language such as HTML or XML. The content can include images including video and PGE assets. Several suitable servers are commercially available such as those from Apache, Google, Microsoft, and Nginx.

In some embodiments, experience generator 24 includes processor-executable instructions or processor-readable data which when executed cause a server, such as server 20-1, to create an interaction experience for one or more users. Experience generator 24 defines one or more instances of interaction experiences of one or more interaction experience models, such as experience model 26. For example, experience model 26 can be processor-readable data, or processor-executable instructions such as a computer program product or code representations of rules, procedures, processes, data structures, or assemblies thereof. Experience generator 24 may operate in response to user input from a first user at user device 10. In some embodiments, experience generator 24 may include a processor to execute the interaction experience model to generate the instance of the interaction experience. In some embodiments, experience generator 24 includes processor-executable instructions or processor-readable data which when executed, by at least one processor, cause the at least one processor to receive, from a first user device, a plurality of items approved by the first user (e.g. affiliate), and generate a first interaction experience model based on the plurality of items. Experience generator 24 may further include the processor-executable instructions, which when executed, further cause the at least one processor to store, on at least one non-transitory processor-readable storage medium such as storage device 13, the first interaction experience model.

In some embodiments, experience generator 24 stores an interaction experience in an experience model 26. The interaction experience can be code or data representation suitable for storage in the experience model 26. For example, the interaction experience can be in experience model 26 stored in database 30. In some embodiments, experience generator 24 creates experience model 26 in part from a template provided to or selected by the first user.

In some embodiments, the interaction experience is a bespoke or custom, semi-custom, or curated retail experience. For example, the experience generator 24 includes processor-executable instructions or processor-readable data which when executed by a processor cause the processor to generate a curated retail experience which comprises two or more items from an existing merchant inventory. In some embodiments, the processor generates a curated retail experience based on one or more of a retail model, a user model, and user customization inputs. In some embodiments, interaction experience 24 includes instructions, which when executed, cause a processor-based device to share the interaction experience, for example, share a curated retail experience.

In some embodiments, experience generator 24 includes processor-executable instructions or processor-readable data which when executed by a processor cause the processor to provide methods of operation such as is shown and described in the drawings. In some embodiments, experience generator 24 includes instructions which when executed by a processor cause the processor to support methods performed by a first user shown in FIGS. 4A and 4B. In some embodiments, experience generator 24 includes instructions which when executed by a processor cause the processor to provide methods shown in FIG. 5, 6, or 7.

In some embodiments, experience generator 24 and other processor-executable instructions use the different types of processor readable data to define, refine or select one or more interaction experiences. Examples include processor readable affiliate data 31, community data 32, retail data 33, and user data 34.

In some embodiments, affiliate data 31 includes processor-readable data about one or more affiliates and may be used by experience generator 24 and other processor-executable instructions to define, refine or select an interaction experience. Examples of information that may be included in affiliate data 31 are unique affiliate ID, associated affiliate(s), age, age range, gender, activity, activity history, one or more communities, location or region, purchase history of associated guests, membership level, membership history, personal purchase history, physical size or other physical characteristics, lived experience, lifestyle preferences, style preferences, tactile preferences, motivation associated with an individual based on a competitiveness scale and a player orientation to self or others scale, and/or a combination of competitiveness and self-other orientation either associated with an individual or an individual in combination with an activity and/or activity type, social network records, or the like.

In some embodiments, experience generator 24 and other processor-executable instructions use community data 32, processor-readable data about one or more communities, to define, refine or select an interaction experience. A community is a segment of a population, a group, associated with semi-identifying characteristics. Examples of information that may be included in community data 32 comprises unique community ID, associated affiliate(s), associated activities (e.g. sports), community demographics, aggregate purchase amount, community size history, community purchase history, community shared lived experience, community shared fitness levels, community shared fitness achievement, community shared personality type, community shared motivation type, community geographical location, community shared physical size or other physical characteristics, or the like. A community can be defined based on a shared characteristic, collection of characteristics, range of values associated with a characteristic and the like defined in user data 34 and/or affiliate data 31. The community can be defined on a third-party network such as a network to promote social interaction through tracking physical activity (e.g. GPS, accelerometers). Experience generator 24 and other processor-executable instructions can provide better interaction experiences based on community data 32.

In some embodiments, retail data 33 includes processor-readable data about one or more merchants and may be used by experience generator 24 and other processor-executable instructions to define, refine or select an interaction experience. In some embodiments, server 20-1 includes storage device 13 storing therein retail data 33 that is a copy or near copy of retail data 33 stored in another server, such as server 20-2.

In some embodiments, user data 34 includes processor-readable data about one or more user affiliates and may be used by experience generator 24 and other processor-executable instructions to define, refine, customize or select an interaction experience. Examples of information that may be included in user data 34 are unique user ID, associated users, associated affiliates, age, age range, gender, activity, activity history, one or more communities, location or region, purchase history of associated guests, membership level, membership history, personal purchase history, physical size or other physical characteristics, lived experience, lifestyle, style preferences, tactile preferences, motivation associated with an individual based on a competitiveness scale and a player orientation to self or others scale, and/or a combination of competitiveness and self-other orientation either associated with an individual or an individual in combination with an activity and/or activity type, social network records, or the like.

In some embodiments, experience generator 24 or other processor-executable instructions use user data 34 to define, generate, refine or select an interaction experience. The user data 34 includes processor-readable data selected from a group comprising unique ID, age, age range, gender, activity, activity history, preferred mode of activity (e.g. solo, pair, group, online), one or more communities, income, occupation, language, location or region, chronotype, gender, gender preference in co-participants, membership level, membership history, purchase history, participation history, participation plans, scheduled events, wish list, preferred retail store, size, navigational history, subscription history, associated social networks handles, social network records, or the like. In some embodiments, the user data 34 overlaps with one or both of device metadata 19, or affiliate data 31.

In some embodiments, user data 34 includes information related physiological affect (for example increased heart rate or the like), subjective interpretation of physiological affect (for example, interpreting increased heart rate as indicative of fear, indicative of excitement, indicative of enhance athletic performance or the like), and/or lived experience (for example previous contexts and/or experiences that have triggered similar physiological affects for example increased heart rate and/or similar subjective interpretation of physiological affects (for example fear). Physiological affect may be used to determine, refine, select, provide, manage, and update an interaction experience model which may be contextually appropriate and/or effective to a user. The system receives data from one or more input devices 15, 55 that generate different types of input data, such as text entry, physiological metrics, biometric identifiers, video, audio, conversation, image, Global Positioning System (GPS) location, camera input, body mapping with sensors, mapping user position in a physical space, eye tracking, IoT (Internet of Things) input, web browsing history, social media history, purchase history, chat history, EEG signals, Heart Rate HR, Heart Rate Variability HRV, galvanic skin response (GSR), respiratory rate, blood glucose, oximetry rates, weight, body mass index BMI values, body temperature, pH levels.

In an embodiment, the user device in the system further comprises one or more of a biometric sensor, physiological sensor, a room sensor, microphone, still camera, video camera, body-based sensor, smart mat based sensor, smart weight based, smart bike based sensor, smart glove based sensor, garment based sensor, smart footwear based sensor, augmented reality headset, virtual reality headset, metaverse headset, a mixed reality device, a virtual reality device, an augmented reality device. These sensors may be combined in a number of combinations as is evident in the sensor systems which are commercially available.

In some embodiments, experience generator 24 or other processor-executable instructions include one or more method of identifying and/or authenticating an item associated with user data and/or generating an initial list of items. For example, experience generator 24 may authenticate one or more items as one or more authentic branded products.

In some embodiments, the system includes devices for authenticating that a candidate product is an authentic branded product by detecting and reading one or more of a 1D (linear) barcode, 2D barcode, 3D barcode, watermark, microtext, hologram, forensic taggants, a sensor, circuit, printed code, UV code, infrared code, printed smart tag, smart token, Radio frequency identification” (RFID) technology (RFID) tag, Bluetooth Low Energy (BLE) tag, Real-time locating systems (RTLS) tag within, attached to, or on the candidate product. In some embodiments, devices for authenticating are associated with one or more of user device 10, input device 15, and peripheral input device 55.

In some example embodiments, the system involves receiving input, for visual authentication, using LIDAR scanning. The system can use computer vision to receive input, Computer vision may be based on pixel to pixel comparison, color comparison, logo placement, design patterns on the surface, or embedded, such as QR codes and similar identification means.

In some embodiments, there may be pre-authenticated branded products associated with a user or affiliate profile (e.g. a labeled data set), and data associated with those products can be used for authentication. Example data includes version, season, year where logo placement and/or other product identification means may be different for different products. From a user profile, data such as purchase history, gifts received history, gifts given history, pre-authentication, location or region may be used to reduce the set of garments to be authenticated. For chips associated with or potentially applied in conjunction to computer vision authentication, RFID/UWB (Ultra-Wideband) have greater range for sensor detection. The system can use different types of product marking such as UV, InfraRed, internal light/energy reactive elements (similar to x-ray) printing on, embedding in, and or containing products to extract or obtain data about the products. There are a number of candidates for product authentication and different combinations of data based on user profile and visual detection can be used.

In some embodiments, an RFID transponder system is provided. With user devices and/or Input devices and/or components including an antenna/interrogator functioning type component for receiving RFID information from a RFID chip, label, and/or tag on or within the candidate product. In some embodiments, the authentic branded product contains an RFID chip, label, or tag component which may be a factor used to determine authenticity. The RFID transponder may be Ultra-High Frequency, (UHF), High Frequency (HF) and/or Near Field Communication (NFC), Low Frequency (LF), Dual Frequency Ultra-High Frequency (UHF) and near Field Communication (NFC), or a combination thereof. In some embodiments, Ultra-High Frequency is preferred for its range, speed, and capacity with a dense tag population and/or movement.

In one embodiment, the system can detect the authenticated branded product displayed by a user (such as an affiliate or guest) and determine affiliate data 31, user data 34, retail data 33, or community data 32 related to the authenticated branded product.

In some embodiments, the system includes instructions for authenticating that the candidate product is an authentic branded product by detecting and reading one or more of a 1D (linear) barcode, 2D barcode, 3D barcode, watermark, microtext, hologram, forensic taggants, a sensor, circuit, printed code, UV code, infrared code, printed smart tag, smart token, Radio frequency identification” (RFID) technology (RFID) tag, Bluetooth Low Energy (BLE) tag, Real-time locating systems (RTLS) tag within, attached to, or on the candidate product. The system uses different hardware components to implement the authentication.

In some embodiments, server 20-2 includes processor-executable instructions which when executed by a processor cause the processor to provide and manage an interaction experience, such as, a custom or semi-custom interaction experience with a social network, for example, an online community. The community may be directed to one or more sports, or other activities, like knitting, collecting, sewing, a shared-lived experience, a shared identity, a shared physical characteristic, a combination of more than one shared activities, experiences, identities and/or characteristics and so on. In some embodiments, processor-executable instructions and/or processor-readable data 17 includes one or more of web server 22, interaction server 40, merchant server 47, retail data 33, and database 30. Database 30 may include one or more of experience model 26, affiliate data 31, community data 32, retail data 33, or user data 34.

In some embodiments, interaction server 40 includes processor-executable instructions which when executed by a processor cause the processor to refine, select, provide, or manage an interaction experience. In this way server 20-2 can be optimized to provide interaction experiences and server 20-1 allows users to define an interaction experience. Further aspects of interaction server 40 are described in relation to FIG. 2. In some embodiments, interaction server 40 includes instructions which when executed by a processor cause the processor to support methods performed by a second user (e.g. guest) as shown in FIG. 10, or provide methods shown in FIG. 8, or 9.

In some embodiments, interaction server 40 or other processor-executable instructions use(s) retail data 33 to refine, select, provide, or manage an interaction experience. Retail data 33 may include one or more subsets such as inventory data 41, item descriptions 42, geographic model 43, substitution model 44, promotion model 45, and so on. Inventory data 41 includes processor-readable data such as numbers, locations, and other attributes of items. Geographic model 43 may includes processor-readable data on location varying aspects of the inventory or offering items for sale including regional availability, regional pricing, or regional sizing. The substitution model 44 may include processor-readable data on alternatives items, such as, similar item matching, color matching, cross-sell, upsell, or the like. Thus, the substitution model 44 may include suggestions even if an item is available, e.g. upsell, promoting feel-state compatibility, cross-sell, excess inventory. Promotion model 45 may include processor-readable data on promotions such as gated-access (e.g. differential access based on membership or membership level, time limits), rewards (e.g. award badge, issue membership, update membership level), or discounts (e.g. excess inventory, seasonal, volume, or coupon based discounts).

In some embodiments, merchant server 47 includes processor-executable instructions and/or processor-readable data which when executed by a processor cause the processor to process orders, and maintain records. In some embodiments, merchant server 47 is able to access database 30 to read, edit, and write records. Merchant server 47 may include an order management subsystem 48 or an enterprise resource planning subsystem 49. Enterprise resource planning subsystem 49 (ERP) includes processor-executable instructions and/or processor-readable data which when executed by a processor cause the processor to maintain records for accounting, inventory, logistics, suppliers, tracking, and reporting. Merchant server 47 may include processor-executable instructions and/or processor-readable data for inventory management which when executed by a processor cause the processor to provide numbers, location, and other attributes of items.

The exemplary interaction system 100 shown in FIG. 1 can implement different types of interaction experiences. System 100 can collect and process different data sets, such as user data and community data, to generate interaction experience models and instances of interaction experiences. System 100 can use sensors for performing measurements for user physiological inputs as another example data set. System 100 can use sensors for product authentication in other example embodiments. System 100 can use fit surrogates to identify items, and/or to generate or update interaction experience models and instances of interaction experiences. System 100 can generate or update interaction experience models and instances of interaction experiences to achieve a specific look or fashion intervention in other embodiments. System 100 can use fit surrogates to identify items, and/or to generate or update interaction experience models and instances of interaction experiences for different user contexts (e.g. pregnancy), for structured training goals or objectives reflected by one or more affiliates or influencers, shared within the community or associated with user/affiliate metadata. System 100 can use purchase history and/or authenticated products to identify items, and/or to generate or update interaction experience models and instances of interaction experiences, as the data may be useful for an implicit selection of items for interaction experiences.

Turning to FIG. 2 which shows an exemplary interaction system 200 in accordance with the present systems, devices, articles, and methods. System 200 is an example of a system that when operated selects, refines, offers, or manages an interaction experience for second a user (e.g. guest, customer). Various components of interaction system 200 described or shown are optional in presence and numbers (e.g. omitted, present in a plurality, present singly), or may be split or combined. Interaction system 200 includes at least one user device 10, a server 20, and a network 50 communicatively coupled to the at least one user device 10 and server 20.

The exemplary interaction system 200 shown in FIG. 2 includes at least one user device 10, such as illustrated user device 10-1 and user device 10-2. A respective pair of user devices in a plurality of user devices, such as user device(s) 10 may be the same type or different types of devices. The at least user device 10 includes hardware processor 12 communicatively coupled to and operable to access storage device 13, network interface subsystem 14, input device 15, or output device 16 by bus 11.

In some embodiments, at least user device 10 comprises storage device 13 that includes or stores processor-executable instructions and/or processor-readable data 17. In some embodiments, processor-executable instructions and/or processor-readable data 17 includes a BIOS, an OS, peripheral drivers (not shown), user device application 18, device metadata 19, experience generator client 25, and experience consumer client 27.

In some embodiments, user device 10-2 includes peripheral input device 55. In some embodiments, user device 10-2 includes peripheral output device 56. In various embodiments, different user device types are formed from combinations of different types of user device 10-2, peripheral input device 55, and peripheral output device 56.

Examples of the peripheral input device 55 include different types of input devices like controllers and sensors and examples of the peripheral output device 56 include output devices like display and annunciators as found in: a smart phone, a tablet, a computer, a smart mirror, a wearable device (e.g. smart clothing, smart watch, smart jewelry, myographic band), a haptic interface (e.g. haptic display, haptic glove, haptic footwear), a connected device (e.g. a yoga mat, a vehicle, cardiovascular exercise equipment, isometric or isotonic exercise equipment), a smart audiovisual system (e.g. smart speaker, lighting system), a wearable sensor (e.g. breathing monitor, blood glucose monitor, EEG, myographic band, heart rate monitor, blood oxygen monitor), an interface for processor generated experiences (e.g. headset, goggles, gloves, controllers for artificial neural networks, augmented, augmented or virtual reality), or the like. In some embodiments, the output device(s) 56 can provide the interaction experience model for the user. For example, the output device(s) 56 can display the interaction experience (e.g. visual interaction experiences), or otherwise provide the interaction experience (e.g. audio interaction experiences, tactile interaction experiences). A peripheral input device 55 (such as a sensor or controller) can perform measurements or operations relating to items or users. These measurements or operations can be used to define or identify items that are approved by users, for example. Items that are approved by a user can be used to generate interaction experience models. A peripheral output device 56 can present an instance of an interaction experience that is generated based on the first interaction experience model. This can be defined in processor-executable instructions which, when executed by the client processor causes the peripheral output device 56 to display the instance of the first interaction experience model.

The server 20 includes hardware processor 12 communicatively coupled by a bus or buses (not shown) to storage device 13, database 30, network interface subsystem, input subsystem, and output subsystem (not shown). Storage device 13 includes or stores processor-executable instructions and/or processor-readable data 17 associated with the operation of interaction system 200. Execution of processor-executable instructions and/or processor-readable data 17 causes processor 12 or server 20 to carry out various methods and actions. Processor-executable instructions and/or processor-readable data 17 can, for example, include a BIOS, an OS, or peripheral drivers (all not shown), a web server 22, experience generator 24, interaction server 40, merchant server 47, and database 30 storing a plurality of data sets such as one or more experience models 26, affiliate data 31, community data 32, retail data 33, and user data 34.

In some embodiments, interaction server 40 or other processor-executable instructions uses data stored in or provided to at least one server 20 to generate, refine, select, provide, or manage an interaction experience. In some embodiments, interaction server 40 includes processor-executable instructions which when executed by a processor cause the processor to receive, from a first respective user device in the plurality of devices, a request for an interaction experience, and generate a first instance of the interaction experience based on the first interaction experience model. The interaction experience is based on a first interaction experience model including a plurality of items approved by a first user (e.g. an affiliate).

In some embodiments, user device 10-1 provides a different interaction experience than user device 10-2. For example, a first user at user device 10-1 may be directed to a website or a tangible retail location and a second user at user device 10-2 may be presented with a PGE as a retail experience.

In some embodiments, interaction system 200, server 20, and/or at least one user device 10 use cryptographic processes or operations. In some embodiments, interaction system 200, server 20, and/or at least one user device 10 protects privacy of a user associated with at least one user device 10. For example, an individual using user device 10. The server 20 can authenticate the user individual using user device 10-1 or user device 10-1. In some embodiments, server 20, and/or at least one user device 10 encrypt information sent through network interface subsystem 14 or network 50.

In some embodiments, server 20, and/or at least one user device 10 encrypt information stored in storage device 13. In some embodiments, server 20 manages gated-access to an interaction experience offered by server 20. For example, server 20 provides gated-access (e.g. differential access based on membership or membership level, time limit, location) to a first user associated user device 10-1 but not a second user associated user device 10-2. The gated-access may be time limited to provide an early access to items for certain people that are defined by attributes such as membership, membership level, or location. The gated-access by location can facilitate a location based social activity including an augmented reality scavenger hunt; location based social network search; fitness activity like a timed challenge such as a hill climb for a cyclist; and the like. In some embodiments, server 20 manages gated-access a first user to define an interaction experience. For example, access may be limited based on invitation or qualifications (e.g. member, membership level, number of followers, certification). Further examples of gated-access are described herein including with respect to FIG. 3.

Turning to FIG. 3, there is shown a schematic diagram illustrating a portion of an interaction system 300 including a plurality of individuals segmented into a plurality of communities and interacting with at least one server. Interaction system 300 includes processor-readable data 302, used in a plurality of processing operations, controllers, or servers 304, and a plurality of individuals 306. The plurality of individuals 306 are segmented into a plurality of communities, such as, community 308 and community 310.

In some embodiments, community 308 includes a first user (individual A), an affiliate, who interacts with interaction system 300 to define an interaction experience for members of community 308. Community 308 can be defined by one or more common attribute values described herein for community data 32.

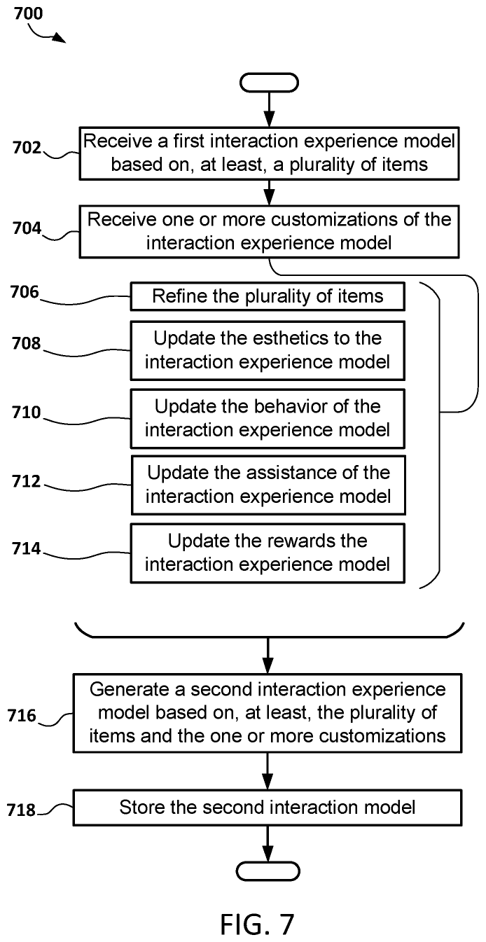

As shown schematically in FIG. 3 the affiliate provides user input 312 to experience generator 24. In some embodiments, user input 312 includes providing an approved list of items for an interaction experience. The first user may follow methods described in relation to FIGS. 4A and 4B. In some embodiments, user input 312 may involve input device 15 and/or peripheral input device 55 which may include one or more sensors or controllers. For example, input device 15 and/or peripheral input device 55 can perform measurements or operations relating to items or users. These measurements or operations can be used to define or identify items that are approved by users, for example. Items that are approved by a user can be used to generate interaction experience models. In some embodiments, user input 312 includes providing one or more customizations for an interaction experience. The first user may provide the one or more customizations through methods described in relation to FIG. 7.

In some embodiments, user input 312 includes defining one or more of pieces of processor-readable data that may be included in processor-readable data 302, for example, affiliate data 31, community data 32, retail data 33, and user data 34. Experience generator 24 may place the user input 312 in processor-readable data 302 and/or define an interaction experience model 26.

In some embodiments, experience generator 24, in response to the execution of processor-executable instructions, uses processor-readable data 302, for example, interaction experience model 26, to define an experience link 314. For example, if community 308 was based around pie eating then experience link 314 could feature a pie, a pie eating competition, a cooking class, or the like.

In some embodiments, the experience link 314 is processor-readable data that define access to a server providing an interaction experience based on an interaction experience model. The experience link 314 may be processor-readable code that instructs or controls access to a server. The experience link 314 may feature representative information (e.g. audio, image, text) based on a plurality of items like a series of baking classes. The experience link 314 may feature representative information for a plurality of items arranged in an array or under the visual metaphor of pinned to a board. In some embodiments, the experience link 314 features a carousel of items each with representative information. The experience link 314 may feature representative information based on a representative item in the plurality of items like the image of a lemon tart or cherry pie. In some embodiments, the experience link 314 may feature representative information recognizable as apparel such as complete picture, silhouette; a part of a garment like hidden pocket, support web (e.g. second bra strap, overstitched seam, particular fabric), or representations the benefits of the apparel like sweat, or perfect pose (e.g. savasana).

In some embodiments, the experience link 314 includes one or more hyperlinks 316. A navigational link from one document to another, or from one part of a document to another. Typically, a hyperlink is displayed as a highlighted string or image that can be selected to invoke navigation to the associated document or part. In some embodiments, the experience link 314 includes zero, one, or more pieces of representative information 318, defined above, that may be part of or ancillary to the hyperlink, e.g., tool tip, teaser image. In some embodiments, representative information 318 is omitted.

In some embodiments, the experience link 314 includes zero, one or more ID 320, identification of an entity, such as, an affiliate, community, guest, model, or the like. In some embodiments, an ID 320 is a unique linking code that enables the host to electronically track any activity that starts with experience link 314. In this way the host can track an entity like an affiliate or model. In some embodiments, the one or more ID 320 is used to generate interaction activity summary data comprising at least one of: a number of click-through events for experience link 314, a number of users that interact through interaction experience starting with click-through events for experience link 314, a quantity of sales resulting from the click-through events for experience link 314, and rewards (e.g. badges, commissions, promotions) for the affiliate for the activity resulting from the click-through events for experience link 314.

One or more individuals included in community 308 may use experience link 314 to start an interactive experience. This includes individual B, C, D, and the affiliate A. The interactive experience may be provided by interaction server 40. Examples of operations of interaction server 40 are described further herein. As experience link 314 is for community 308, it is shown as used by community 308. However, a different link associated with a second experience could be created for further communities, such as, community 310.

In some embodiments, an affiliate may have one or more identified physical characteristic such as body size, a set of body sizes, sex, body composition, a set of body compositions, height, weight, a set of weights, physical measurements, a set of physical measurements, other specific physical characteristics and the like and function as a fit surrogate for other users included in the community defined based on one or more affiliate associated identified physical characteristic. In some embodiments, an affiliate may have an identified gender identity, or set of gender identities, which may be used to define a community with other users based on one or more shared gender identity. In some embodiments, one or more of an affiliate's physical characteristics and/or gender identity enable the affiliate to function as a fit surrogate for other community users with similar characteristics and/or gender identities. In some embodiments, a fit surrogate interaction experience model is only available to users who share one or more of a physical characteristic, a set of physical characteristics. The terms shared or common as used herein can extend to similar ranges of physical characteristics, similar ranges one or more gender identity, and so on. Accordingly, the system 200 can generate a fit surrogate interaction experience model as the interaction experience model, or as a part of the interaction experience model. The system 200 can identify one or more shared or similar physical characteristics associated with the affiliate and a user or community of users. As another example, the system 200 can identify one or more shared or similar gender identities associated with the affiliate and the user or community of users. The system 200 can generate the fit surrogate interaction experience model using the shared one or more physical characteristics, the one or more shared gender identities, and affiliate data associated with the affiliate. The fit surrogate interaction experience model can be used for users of a community that can be defined based on a common physical characteristics, sizes, size range, and so on.

In some embodiments, an affiliate, affiliate data or metadata, may identify one or more of achieving a specific appearance, activity, lifestyle, style, or performance objective, engaging in a journey related to an appearance, activity, lifestyle, style, or performance objectives, or a combination. For example, an affiliate may be identified as new mom with a casual chic style who is training for a 10K race and a user in a community associated with the affiliate may have one or more shared characteristic such as identifying a preference for a casual chic style, training for a running event, being a new mom, or the like. In some embodiments, an affiliate may be associated with a specific type of lived experience, fashion intervention associated with a lived experience, or the like. Examples of specific fashion interventions include defining a preferred wardrobe for a new role or identity for example attending university, a career/industry, motherhood, for engaging in a specific activity or activity in specific conditions, cold weather long distance running, etc.

In some embodiments, the affiliate A provides user input 312 to experience generator 24 based on their previous purchases, gifted items, items that have been tried on or tested, tagged images of user wearing an item of apparel, reviewed items, authenticated product ownership, uploaded images of user with or wearing a item, uploaded images of user with or wearing an authenticated item, or the like to define a personal closet or “wardrobe”. In some embodiments, user input 312 includes providing a list of apparel items associated with the affiliate size or a specific fit on affiliate A. The first user may follow methods described in relation to FIGS. 4A and 4B. In some embodiments, user input 312 may involve input device 15 and/or peripheral input device 55 which may include one or more sensors or controllers. For example, input device 15 and/or peripheral input device 55 can perform measurements or operations relating to items or users. These measurements or operations can be used to define or identify items that are approved by users, for example. Items that are approved by a user can be used to generate interaction experience models.

In some embodiments, community 308 includes a first user (individual A), an affiliate, who interacts with interaction system 300 to define an interaction experience for members of community 308. Community 308 can be defined by one or more common attribute values described herein for community data 32.

A community can be defined based on data or metadata associated with a wide range of shared, or partially shared, characteristics. For example, data pertaining to one or more of user specified preference, user specified goal, user specific wellness objective, user specified training plan, user skill baseline, user wellness baseline, user personality baseline, user activity baseline, user habit, user activities, contextual data about user habit, contextual data about user activity, user fitness class history, user purchase history, user community participation, user exercise logs, user biometric records. Information related to a user context includes lived experience, current location, planned future location, current weather, anticipated weather, scheduled events, sleep schedule, childcare schedule, work schedule, availability of a workout partner, availability of a workout partner at a future time, access to equipment associated with a location, access to equipment associated with a planned future location, access to terrain associated with a location, access to terrain associated with a planned future location. In some embodiments, the one or more common characteristics is based on one or more of a shared life experiences (such as a significant life change, positive life experience, trauma, abuse), a shared determinant of health (such as income and social status, education, employment, social support, housing, food insecurity, transportation, environmental factors, health care, discrimination) a shared wellbeing measurement (such as measures of mental health, physical health, and overall quality of life (self-reported measures of stress, anxiety, depression, and satisfaction with life), a shared sociodemographic factor such as (age, gender, race, ethnicity, education level, and income level), a shared behavioral characteristic and/or measurement (such as physical activity, diet, sleep, substance use, social interaction, coping strategies, stress management, risky behaviors), a shared physiology, and the like.

In some embodiments, the interaction experience, accessed by experience link 314, is a retail experience comprising several ways a guest (e.g. customer, potential customer) can experience an item. The guest experiences a point of view defined by the affiliate. In addition to providing a storefront, product information, and/or one or more affordances to purchase an item, a retail experience may include other ways in which guests interact and interface with an item such as, those occurring in a retail experience, in a hybrid experience, or outside a retail experience include demos, product testing, product placement, test drives, tastings, feeling or trying on apparel or product, recommendations and answers from other consumers, unboxing videos and the like. These retail experiences may occur in physical retail settings, virtual reality, online retail, the metaverse, hybrid retail, and or other contexts such as a friend's kitchen, a yoga studio, a third-party website or video, and the like. A specialized retail experience may be integrated within a larger retail context, a retail context, a social network context, or may be provided as a stand-alone experience.

FIG. 4A is a schematic diagram illustrating a plurality of different workflows (method 400) that a first user may follow to provide an approved plurality of items. FIG. 4B is a schematic diagram illustrating a plurality of possible workflows (method 450) that a first user may follow to provide one or more customizations. While FIGS. 4A and 4B illustrate method 400 and method 450 from the perspective of a first user, like an affiliate, a person of ordinary skill in the art will see the equivalent implementations of actions for a server-side processor-based device. For FIGS. 4A and 4B, as with other methods taught herein, the various acts may be performed in a different order than that illustrated and described. Additionally, the methods can omit some acts, combine acts, split acts, and/or employ additional acts.

Before turning to the methods 400 and 450, different advantages to a first user to create an interactive experience as an affiliate to a host are described. For example, the user does not have to design, make, or sell a single item. The user can however market items with benefit to them or a community. The first user's interaction experience can reflect their point of view and thus be an extension of the self. Thus, a second user, a guest, participates in the experience with a sense of the perspective of the first user and possibly who they are. The first user creates a suitable experience for the second user even though the experience is offered by a host that provides general experiences for all guests. Thus, the experience is on brand for the host but specific to a user. For more on the second user's experience see FIG. 10. As well, the first user runs their experience in an agile and ad hoc way. Their experiences can be time limited (e.g. retreat, pop-up store). However, in some cases, the first user does design items. For example, in services provided or supervised by first user but also in semi-custom goods such as apparel with special color for, or prints on, material or applied designs (e.g. silk screen, embroidery). In this way the host can engage in mass customization without an a la carte program (known as, “made for me”, “build your own”) requiring coordination between customer and factory floor (along with the associated time delay). The first user provides the design and the host invests in production with concrete knowledge of past sales through the first user's interaction experience. As another example, the first user in cooperation with the host of a retail experience can offer items designed by the first user and sold by pre-sale (e.g. buy now, delivery if sales threshold met, else refund money).

Method 400 optionally begins at 402 where a first user generates an initial list of items from items in a catalog. The first user may be an affiliate. In some embodiments, the first user generates an initial list of items from amongst those in a catalog of items offered by the host, e.g. merchant, social network provider, social network partner. Examples of where the first user generates the initial list of items include those shown in acts 404.

Acts 404 can be implemented when the first user has a history of interactions with the host, for example, as a guest, affiliate, or employee. The generation of the initial list can be expressly provided by the user 406 and/or implicitly provided 408. Examples of express provision of a list of items (406) include the first user providing or the host processing: purchase history, item review history (e.g. write, read, like), item wish lists, likes of items, or the like. For example, a merchant can track a user's purchases or reviews to create an initial list of items. The host may also process a wish list of items, searched for items, liked items, or the like provided by the first user. The first user may be a user of a device for PGEs and the first user may have expressly clicked on a representation of an in a PGE and added the item to their associated record. For example, the first user may have noted a running group in a virtual world, itself a representation of online class, or noted a pair of shorts in a PGE including a retail experience. In some embodiments, the first user selects an action in an interface to remind them later, e.g. remind me about the group, or shorts.

Examples of implicit provision of an initial list of items (408) include processing the interaction history of the first user, detecting user's preferences, estimating user's preferences, or the like. For example, the first user in front of a smart mirror in an exercise class may repeatedly keep their gaze on the instructor's top. In another example, the first user may request the smart mirror show the user wearing an outfit in an augmented reality experience. The user device (e.g. smart mirror, smart glasses) could record these garments as items for the initial list. The user may provide implicit preferences to goods through purchase of services and the reverse. An implicit list may be generated based on user (and/or guest associated with user and/or affiliate) purchase history, gift history, authenticated products, product reviews, product likes, product mentions, or the like to generate an initial list. In one embodiment, the initial list may be generated based on an associated guest “wardrobe” which includes purchased or gifted products associated with the guest. Items associated with running can be suggested, for example, to a user that is a member of a running group. Likewise, a participant in baking classes or a community could be suggested cookware.

Examples of implicit provision of an initial list of items (408) include processing the interaction history of members of a community associated with the first user, detecting community's preferences or change in preferences, or the like. In some implementations, the first user is aided by suggestions of items based on the interaction history of members of a community.

Examples of implicit provision of an initial list of items (408) include detecting a user's preferences by processing data related to a user. For example, a set of items may be generated by an object recognition process for a haul video posted by the user. A user may provide responses to a quiz that determines a user's preferences for activities, color, silhouette, feel-state in apparel, or the like. A user may provide responses to a quiz that determines a user's preferences in response to personality test. In some embodiments, processing the quiz responses leads to the inclusion or exclusion of items in the generation of the initial list of items 408.

At 410, the first user interacts in a gamified way with the host. In some embodiments, this includes generating implicitly or expressly a list of items from those in a catalog that may be refined into a suggested plurality of items. In some embodiments, the first user creates a store in a simulated world. The selection of items, size of store, and esthetic of store can all be included in generation of a list of items or experience model.

In some embodiments, the initial list of items is composed of items combined from those expressly provided by the first user 406), implicitly provided (408), or provided in a gamified way (410). Processing of the initial list of items continues at, for example, 412.

In some embodiments, the initial list of items includes one or more specific model or version of an item based on an item characteristic, for example item size, model, color, print, coating, material, season, length, gender, component, customization.

Method 400 optionally includes 412 where a first user creates an approved plurality of items. In some embodiments, the first user creates the approved plurality of items from the initial list of items defined in earlier acts. In some embodiments, the first user creates the approved plurality from an empty initial list. Examples of where the first user creates the approved plurality of items include those shown in acts 414. Each of acts shown in acts 404 or acts 414 are optional.

In some embodiments, at 416, the first user receives an invitation to create an interaction experience. This invitation may include or be associated with a suggested plurality of items, such as, the initial list of items or based on the initial list of items. For example, the suggested plurality of items can be the intersection of the initial list of items and available items over a future period. The available items include courses next quarter with capacity, goods in a merchant's next season, or the like.

In some embodiments, at 418, the first user accesses an interface for affiliates. For example, the user can access an interface generated by web server 22 and displayed on user device 10. The first user can enrol as an affiliate. In some embodiments, method 400 continues at 422.

At 412, the first user can act in a self-motivated way to become an affiliate. This includes performing one or more acts like act 418 and act 420. In some embodiments, at 418, the first user accesses an interface for affiliates. The first user can enrol as an affiliate. At 420, the first user reviews a catalog of items to create a plurality of items. In some embodiments, the first user adds each item to the plurality of items. In some embodiments, the first user is aided by suggestions.

At 422, the first user approves a plurality of items. In some embodiments, the first user is given the option to edit the plurality of items. The approval by the first user creates the approved plurality of items.

At 424, the first user submits an approved plurality of items. In some embodiments, the approved plurality of items is a subset of a catalog of goods offered by a merchant. With alternatives and optional acts method 400 has many embodiments. Method 400 ends until repeated by the first user.

Referring to FIG. 4B which illustrates an example method 450. Method 450 includes acts that can be performed amongst acts in method 400. Method 450 can be implemented by methods described herein including in reference to FIG. 7.

Method 450 optionally begins at 452 where a first user selects a template or model for an interaction experience. The first user can base or rebase their interaction experience on template (e.g. model without content) or an existing model. Use of a template is further described herein with reference to, at least, FIG. 5. At 454, the first user submits customizations for the interaction experience. Examples of customizations are described herein including in reference to FIG. 7. Method 450 ends until repeated by the first user, or another user.

Turning to FIG. 5 which illustrates an example method 500 of operation for an interaction system, such as, interaction system 100. For method 500, as with other methods taught herein, the various acts may be performed in a different order than that illustrated and described. Additionally, the methods can omit some acts, combine acts, split an act, and/or employ additional acts. One or more acts of method 500 may be performed by one or more circuits, for instance one or more hardware processors. In some implementations, method 500 is performed by a controller, e.g., processor 12 of interaction system 100.

Method 500 can begin by invocation from a controller.

At 502, the controller, receives a plurality of items approved by an affiliate. For example, the controller receives a list of goods offered for sale by a merchant, the host, and endorsed by an affiliate. In some embodiments, the items are experiences provided by a host such as a PGE.

At 504, the controller generates an interaction experience model based on, at least, the plurality of items. For example, the controller generates an interaction model for a retail experience base on a list of goods sold by the host and for which the affiliate believes are suitable for a community associated with the affiliate. The associated community may be associated with a community identifier. In some embodiments, the interaction experience model depends on the host or details of the host. For example, if the host provides a retail experience, then the model includes a first experience model with option to purchase items and if the host provides peer-to-peer community interactions then the model facilitates communication between a plurality of users.

In some embodiments, the controller generates an interaction experience model based on, at least, the plurality of items, and a template for an interactive experience. For example, the template could be a starting point for to define a group including events, images, content feed, or for a service (e.g. personal trainer), or a boutique retail experience. In some embodiments, a first user selects the template. In some embodiments, the template defines a boutique-type retail experiences which allows the first user to curate a specific set of items focused on a quality level, item type, an activity associated with one or more items, aesthetic, material composition of a good, and the like. In some embodiments, the template provides assets the first user can accept or replace such as music, images, color schemes, workflows, and the like.

At 506, the controller stores the interaction experience model. For example, the controller stores, on the at least one non-transitory processor-readable storage medium, the interaction experience model. For example, the controller stores the interaction experience model in database 30 in at least one server 20 in interaction system 100.

Method 500 ends until invoked again.

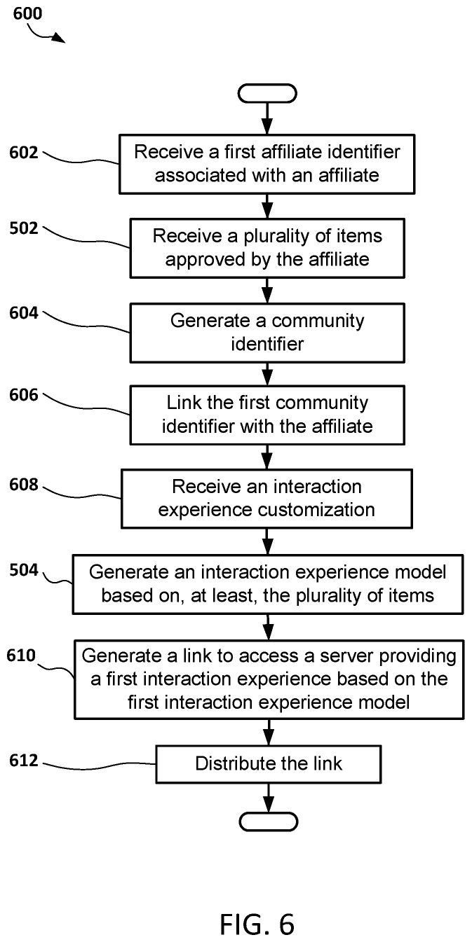

Turning to FIG. 6 which illustrates an example method 600 of operation for an interaction, such as, interaction system 100 or system 200. For method 600, the various acts may be performed in a different order than that illustrated and described. Additionally, the methods can omit some acts, combine acts, split an act, and/or employ additional acts. One or more acts of method 600 may be performed by one or more circuits, for instance one or more hardware processors. In some implementations, method 600 is performed by a controller, e.g., processor 12 of interaction system 100.

Method 600 can begin by invocation from a controller. At 602, the controller receives an affiliate identifier. For example, the controller receives an affiliate identifier from a user device associated with a first user. The identifier can include access credentials, authentication credentials, email address, username, or the like. The controller may receive one or more affiliate identifiers associated with one or more affiliates. For example, individual A in community 308 and individual E in community 310 shown in FIG. 3.

At 502, in method 600, the controller, receives a plurality of items approved by an affiliate. For example, the controller receives user input 314 from an affiliate in community 312 as shown in interaction system 300.

At 604, the controller generates a community identifier. The community identifier is associated with a community and, optionally, the affiliate. The community identifier can be defined based on a sport, a location, the affiliate identifier associated with the affiliate, an affiliate identifier associated with a plurality of affiliates, or the like, or a combination. For example, an affiliate could be a leader of a running group so the community is based on sport, location, and affiliate. In some embodiments, the community identifier is a transitory value including one or more common or near common attribute values for a plurality of individual, e.g. activity, retail history, location, social network interactions.

At 606, the controller links the community identifier with the affiliate. In some embodiments, the association is one to one. In some embodiments, the association is many-to-many with at least one affiliate associated with a plurality of communities, or at least one community associated with a plurality of affiliates or with reverse cardinality.

At 608, the controller receives an interaction experience customization provided by the affiliate. The interaction experience customization can include rewards, and the like. Further examples are described in FIG. 7.

At 504, the controller generates an interaction experience model based on, at least, the plurality of items. In some embodiments, controller generates the interaction experience model based on the plurality of items and interaction experience customization.

At 610, the controller generates a link to access the interaction experience. For example, the controller generates an identifier for the interaction experience model. The controller encodes the identifier for the interaction experience model in a link. In some embodiments, the controller generates a first link to access a server providing the interaction experience. The first link includes the identifier for the interaction experience model. In some embodiments, the controller generates a second link to access the server providing the interaction experience featuring a first respective item includes in the plurality of items. For example, instead of providing a referral to host for two or more items the affiliate focuses on an interaction experience that at least starts with the one respective item.

At 612, the controller distributes (e.g. returns) the link to access the interaction experience. For example, the controller is processor 12 and returns the link from at least one server 20 to user device 10 through network 50 as shown in FIG. 1. In other examples, the controller distributes the link from server 20 to user device 10-2 through network 50 as shown in FIG. 2. The controller may distribute the link to a first user that defined the interaction experience or a second user, e.g. a guest. Method 600 ends until invoked again.

Turning to FIG. 7 which illustrates an example method 700 of operation for an interaction, such as, interaction system 100 or system 300. One or more acts of method 700 may be performed by one or more circuits, for instance one or more hardware processors or a controller, e.g., processor 12 of interaction system 100.

Method 700 can begin by invocation from a controller. At 702, the controller receives an interaction experience model. For example, the controller receives a first interaction experience model based on, at least, a plurality of items. The plurality of items have suggested to or approved by an affiliate. See FIG. 3, 4, 5, or 6 for more details. In some embodiments, the controller receives an identifier that resolves to a first interaction experience model.

At 704, the controller receives one or more customizations of the interaction experience model. The customization may include one or more examples customizations 706, 708, 710, 712, 714, or others.

At 706, the controller receives from an affiliate, processor-readable data to refine the plurality of items. For example, the affiliates edits the plurality of items principally comprises of goods by activity, color, color group, fabric, gender, apparel season, garment type, price, region, size(s), silhouette, style, feel-state, or the like. For example, the affiliates edits the plurality of items principally comprised of services by activity, group size, location, price, region, or the like. In some embodiments, the affiliate provides one or more items to include in the plurality of items. In some embodiments, the affiliate provides one or more items to remove from the plurality of items. In some embodiments, the controller provides a suggested set of changes to the plurality of items. These changes may be based on the history of the affiliate with the host. See description herein relating to FIGS. 4A and 4B.

At 708, the controller receives from an affiliate, processor-readable data to update the esthetics to the interaction experience model. For example, the affiliates edits pre-sets or values color, themes, sound, videos, images, image sets, including images provided or selected by a user, strings, branding, look and feel, and the like. For example, the updates associate the first interaction model with the affiliate and not the host.

At 710, the controller receives from the affiliate, processor-readable data to update the behavior of the interaction experience model. Examples of behavior include navigation that may be defined an action or an inaction like an allowed or blocked transition between states in the interaction experience. Behavior includes gated-access to and within the interaction experience. Gated-access includes time limited access, personal use only, limitation to associates of the affiliate (e.g. followers, friends, family, people in classes with affiliate), access to anyone with link, anyone with link plus predefined personal attribute values (e.g. gender, location), a combination of these factors, or the like. Behavior includes substitutions or alternatives to the plurality of items. Behavior includes specifying minimum device requirements for the interaction experience. For example, if experience includes an online yoga class the minimum requirements may be a phone but a running class may require a smart phone with GPS and step-counter. The interaction experience may require input and output devices that support a PGE.

At 712, the controller receives from the affiliate, processor-readable data to update the assistance in the interaction experience model. Examples of assistance data include Chabot type, language style, avatar, FAQ entry, search term, help links, messages, or the like.

At 714, the controller receives from the affiliate, processor-readable data to update the rewards the interaction experience model. Examples of processor-readable rewards data include rewards for the customer for following the interaction experience and rewards for the affiliate for one or more customers following the interaction experience. Rewards can be monetary (e.g. commission) or non-monetary (e.g. badges, membership-level).

At 716, the controller generates a second interaction experience model based on, at least, the plurality of items and the one or more customizations. At 718, the controller stores the second interaction model. Method 700 ends until invoked again.

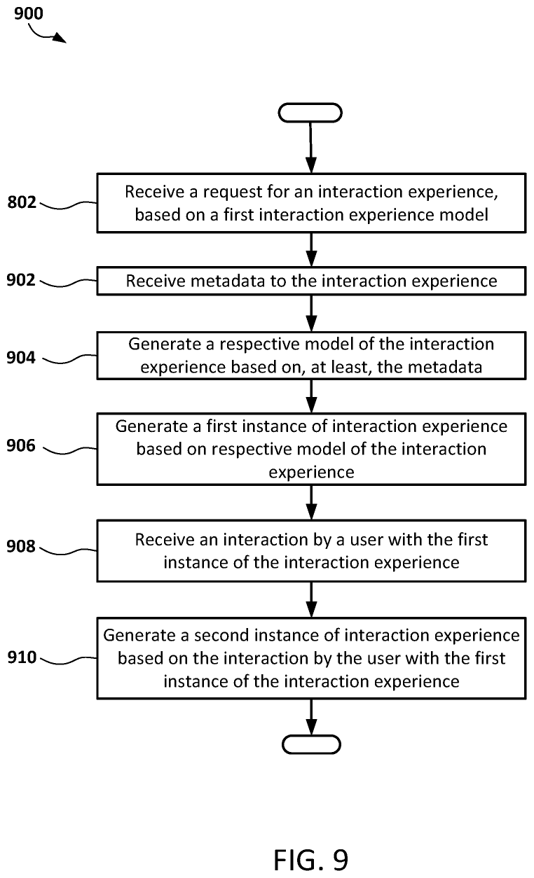

FIGS. 8 and 9 are flow-diagrams illustrating implementation of methods of operation for an interaction system, such as interaction system 200, including generating an instance of interaction experience based on a model of the interaction experience.

FIG. 8 includes method 800 performed by a controller. Method 800 can begin by invocation from the controller. At 802, the controller receives a request for an interaction experience, based on a first interaction experience model. The first model may be based on a plurality of items provided by a first user, e.g. an affiliate. The first model may be based on a customizations provided by the affiliate. The request, at 802, may be from the first user (affiliate) or a second user (e.g. customer, guest). In some embodiments, the controller, receives the request from a first respective user device in a plurality of devices.

At 804, the controller generates a first instance of interaction experience based on the first interaction experience model. In some embodiments, the controller generates a first instance of interaction experience based on the first interaction experience model that includes a plurality of items approved by a first user (see, at least, FIGS. 4A and 4B and related description) and a set of customizations (see, at least FIGS. 4 and 7). An instance is materialized embodiment of the interaction experience with state. Method 800 ends until invoked again.

FIG. 9 includes method 900 performed by a controller. Method 900 can begin by invocation from the controller. At 802, the controller receives a request for an interaction experience, based on a first interaction experience model. The request may be from a device associated with a second user, e.g. customer, guest.

At 902, the controller receives metadata to the interaction experience. The metadata may include one or more types of metadata such as community data, user data, guest data, user device data, retail data, and affiliate data.

At 904, the controller generates a respective model of the interaction experience based on, at least, the metadata. For example, the controller generates an updated model based on the plurality of items and the metadata. The controller may generate one or more additional models, numbered here for clarity, based on the metadata and the first model.

In some embodiments, the metadata includes community data and the controller uses the community data to update the first interaction model to be more suitable for the request for the interaction experience. The suitability may be improved by updating the model to fit the community. For example, the controller creates a second model. Examples of community data are described herein including with reference to community data 32 in FIG. 1, and in reference to FIG. 6. In some embodiments, the request is from a second user and the second model may include a further refined list of items based on histories of users in a community the second user is a member of.

In some embodiments, the metadata includes user data and the controller employs the user data to create a third interaction model to be more suitable for the user, e.g. guest (second user). For example, the controller may generate the third interaction model to be curated for a guest to correspond to their preferred feel-state in apparel. For example, the controller may generate the interaction model to correspond with items, categories of items, similar items the user has wished for, previously purchased, previously purchased more than a year ago, previously purchased in another color, not previously purchased, etc. Further examples of user data are described herein including with reference to user data 34 in FIGS. 1, 2, and 3; and user device metadata 19 in FIGS. 1, and 2. In some embodiments, the user data is used to determine a subset of the plurality of items to include in the interaction experience based on the user metadata. For example if the affiliate interaction experience model is associated with a pregnancy journey and the user metadata indicates that the user is in the second trimester the subset of the plurality of items associated with the second trimester, pre-birth, or another associated duration or milestone, may be included or featured. Similarly, if the affiliate interaction experience model is associated with a training program and the user metadata indicates that the user is in week 6 of the training program the subset of the plurality items associated with week 6, the second half of the training program, completion of a milestone or duration, engaging in a related activity with the phase, or the like may be included or featured.

In some embodiments, the metadata includes user data associated with physiological metrics (for example, EEG signals, Heart Rate HR, Heart Rate Variability HRV, galvanic skin response (GSR), respiratory rate, blood glucose, oximetry rates, body temperature, pH levels) and/or physiological affect. Physiological affect may include, for example increased heart rate or the like, subjective interpretation of physiological affect (for example, interpreting increased heart rate as indicative of fear, indicative of excitement, indicative of enhanced athletic performance or the like), and/or lived experience (for example previous contexts and/or experiences that have triggered similar physiological affects for example increased heart rate and/or similar subjective interpretation of physiological affects (for example fear). Physiological metrics and/or affect may be used to determine, refine, select, provide, manage, and update an interaction experience model which may be contextually appropriate and/or effective to a user.

In some embodiments, the metadata includes user device data and the controller employs the user device data to create a fourth interaction model to be more suitable for a respective user device. Examples of user device data and different types of user devices data are described herein including with reference to FIGS. 1, 2, and 3, at, at least, user device metadata 19, and user device 10. For example, the controller may generate the fourth interaction model to be suitable for an augmented reality experience for a user device with the appropriate display.

In some embodiments, the metadata includes retail data and the controller employs the retail device data to create a fifth interaction model to be more suitable for the state of a merchant. The retail data may be for one or more items in the plurality of items. For example, an item may be out of stock, have a suggestion (e.g. upsell, cross-sell, substitution), not be available in a region, or the like. Examples of retail data are described herein including with reference to retail data 33 shown and described in, at least, in FIGS. 1, 2, and 3.

At 906, the controller generates a first instance of interaction experience based on respective model of the interaction experience. That is, a respective model such as those described and/or numbered here. In some embodiments, the controller generates processor-executable instructions to render the first instance of interaction experience on a representative device in a plurality of devices. For example, a device associated with the second user. In some embodiments, the controller distributes the processor-executable instructions to render an instance of interaction experience.

In some embodiments, the instance of the interaction experience changes with a change in state. At 908, the controller receives an interaction by a user with the first instance of the interaction experience. The interaction may change the state for the interaction experience. For example, the user may have subscribed to a service or purchased an item. They may have left a review for an item or interacted with community members on a social network, e.g. message, post. At 910, the controller generates a second instance of interaction experience based on the interaction by the user with the first instance of the interaction experience.

In some embodiments, the social network may be a membership portal, guest to guest communications system, or the like which may be integrated within one or more of an online retail platform, exercise platform, coaching platform, or the like.

Method 900 ends until invoked again.

Method 900 in FIG. 9 may make use of machine learning processor-executable instructions which when executed by a processor cause the processor to generate a respective model of the interaction experience based on, at least, the metadata. The machine learning processor-executable instruction based on one or more of a combination of unsupervised, supervised, and reinforcement learning. Such machine learning may be performed using processes and evaluation tools such as K-Means Clustering, Hierarchical Clustering, Anomaly Detection, Principal Component Analysis, APriori Algorithm, Naïve Bayes Classifier, Decision Tree, Random Forest Classifier, Logistic Regression, Linear Regression, Regression Tree, K-Nearest Neighbour, AdaBoost, Markov Decision Processes, Linear Bellman Completeness, Policy Gradient, Asynchronous Advantage Actor-Critic (AC3), Trust Region Policy Optimization (TRPO), Proximal Policy Optimization (PPO), Deep Q Neural Network (DQN), C51, Distributional Reinforcement Learning with Quantile Regressions (QR-DQN), Hindsight Experience Replay (HER) and the like. In one embodiment, the machine learning processor-executable instructions are process one or more of a plurality of items, community data, user data, user device data, retail data, and affiliate data.

The method 900, in some embodiments, includes where a controller (e.g. by server 20) generates a respective model of the interaction experience based on, at least, the metadata. In some embodiments, the controller generates a respective model of the interaction experience based on machine learning over data including the received metadata, e.g., received at 904. Method 900 may include recalculation or refinement based on additional data and/or machine learning. The additional data may include feedback from a first user (e.g. affiliate) or a second user (e.g. guest).

FIG. 10 is a schematic diagram illustrating method 1000 that a second user may follow. While FIG. 10 illustrates method 1000 from the perspective of a second user, like a guest, equivalent implementations of actions can be implemented for a server-side processor-based device.

Method 1000 optionally begins at 1002 where a second user interacts with a first user. The first user may generate content engaging to the second user, e.g. social media on a social network. This could include videos (e.g. haul, product testing, shopping, unscripted drama), reviews, images, text, adverts or invites to events (e.g. meet-up, exercise class, retreats), and the like. The second user could note the joy the first user brings to an activity and be curious about their approach to the activity (e.g. mindset, training) or equipment (e.g. app, apparel). The first user can create live content the second user consumes. The first user can incorporate content from others including the second user, e.g. images, reviews.

At 1002, the second user has the option to interact with more than one affiliate. For example, they may review content from one or more affiliates in a content feed. This could include notifications from one or more affiliates. And as described further herein the content may include notifications from one or more followed affiliates for one or more interaction experiences.

In some embodiments, the second user receives suggestions for one or more affiliates. The affiliate can be suggested to the user by a processor-based device, such as server 20 in FIG. 2, based on shared community. Shared community included the same or nearly the same community data including matches over multiple attributes such as activity, demographics, location, personality, social network record or history, retail history, and the like. For example, a second user receives monthly suggestions of affiliates in their area that match their previous purchase history or affinities.

At 1004, the second user receives a link to an interaction experience defined by the affiliate (first user). In some embodiments, this link is included in the content created by the first user. Examples of links are described herein in reference to, at least, FIGS. 3 and 6.

At 1006, the second user follows the link to the interaction experience. The second user requests an interaction experience. Act 1006 is a counterpart to one or more methods described herein including those described with respect to FIGS. 8 and 9.

At 1008, the second user participates in the interaction experience. The second user may thus be interacting further with the first user. The second user may also be adding to one or more content feeds including those of the first user, the second user, a third user (e.g. guest, affiliate), host, or the like. In some embodiments, instances of act 1002 follow instances of act 1008 and the second user receives further notifications. The second user may receive notifications when new content is produced, including links to new or updated interaction experiences. In some embodiments, the second user receives notifications when one or more new items are available through the interaction experience provided by the first user. This could include limited items such as an event, limited production run, drop of (semi-)custom item, and the like.

At Method 1000 ends until repeated by the first user.

Embodiments described herein involve automated systems for receiving inputs, constructing data objects, applying data models, selecting and curating items, based on data related to an individual, similar individuals, communities, cohorts, and digital representations of groups of individuals and specific individuals and providing an interface to a user.

In aspects of embodiments of embodiments, these interaction experiences, are generated as executable code instruction modules, interactive media files, interactive applications, and/or applets.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

The technical solution of embodiments may be in the form of a software product. The software product may be stored in a non-volatile or non-transitory storage medium. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A system for a visual interaction experience, wherein a processor generates one or more visual elements of the visual interaction experience, wherein a visual display device executes an interaction experience model defined in processor-executable instructions to selectively display the one or more visual elements as part of the visual interaction experience, the system comprising:
at least one controller that performs measurements or operations relating to items or the first user;
a first user device of a plurality of user devices, wherein the first user device comprises a client processor that identifies a plurality of items approved by the first user from the measurements or operations;
at least one processor communicatively coupled to the first user device; and
at least one non-transitory processor-readable storage device communicatively coupled to the at least one processor and which stores processor-executable system instructions including an interface that receives the plurality of items approved by the first user device;
wherein the processor:
receives a selection, by the first user device, of a template for an interaction experience; and generates the first interaction experience model based on the plurality of items approved by the first user and the template for the interaction experience;
generates a first interaction experience model defined in processor-executable instructions based on the plurality of items approved by the first user device;
stores the first interaction experience model in the at least one non-transitory processor-readable storage device;
generates an instance of an interaction experience of the first interaction experience model defined in processor-executable instructions by accessing the at least one non-transitory processor-readable storage device, and generates one or more visual elements of the interaction experience; and
wherein a visual display device executes the interaction experience model defined in processor-executable instructions to cause a display screen to display the instance of the first interaction experience model and the one or more visual elements as part of the interaction experience.

2. The system of claim 1 further comprising at least one sensor that performs a portion of the measurements or operations relating to items or the first user, wherein the processor generates the first interaction experience model at least in part using the measurements.

3. (canceled)

4. (canceled)

5. (canceled)

6. The system of claim 1 wherein the interaction experience comprises a fit surrogate interaction experience model, wherein the at least one processor:
identifies one or more shared physical characteristics associated with a first affiliate and the first user;
identifies one or more shared gender identities associated with a first affiliate and the first user; and
generates the fit surrogate interaction experience model using the shared one or more physical characteristics, the one or more shared gender identities, and affiliate data associated with the first affiliate.

7. The system of claim 1 wherein the at least one processor links a first community identifier associated with the first interaction experience model,
wherein the at least one processor generates the first community identifier based on one or more of:
an activity,
a location,
a device type,
a social network record,
a second community identifier,
a first affiliate identifier associated with the first user, or
a second affiliate identifier associated with one or more further affiliates.

8. (canceled)

9. (canceled)

10. (canceled)

11. (canceled)

12. The system of claim 9, wherein:
the plurality of items includes a respective item; and
wherein the at least one processor generates the link to access the server providing the first interaction experience based on the first interaction experience model, wherein the link features the respective item.

13. The system of claim 1 wherein the at least one processor:
receives an interaction experience customization selected by the first user; and
generates a second interaction experience model based on the plurality of items and the set of customization selected by the first user,
wherein the interaction experience customization selected by the first user; is selected from the group comprising: item customization, esthetic customization, behavior customization, assistance customization, and rewards customization.

14. (canceled)

15. (canceled)

16. The system of claim 1, wherein the interaction experience is a retail experience, and the plurality of items are goods and services for sale from a merchant.

17. (canceled)

18. (canceled)

19. A computer implemented method for a visual interaction experience, the method for operation in an interaction system comprising a least one processor, at least one non-transitory processor-readable storage medium communicatively coupled to the at least one processor, and a first user device associated with a first user in communication with the at least one processor, wherein the processor generates one or more visual elements of the visual interaction experience, and wherein a display device selectively displays the one or more visual elements as part of the visual interface experience, the method comprising:
performing measurements or operations relating to items or the first user using at least one controller;
receiving, by the at least one processor from the first user device, a plurality of items approved by the first user in part based on the measurements or operations relating to the items or the first user performed using the at least one controller;
receiving, by the at least one processor from the first user device, a selection of a template for an interaction experience; and
generating, by the at least one processor, a first interaction experience model defined in processor- executable instructions based on the plurality of items approved by the first user and the template for an interaction experience;
storing, by the at least one processor on the at least one non-transitory processor-readable storage medium, the first interaction experience model; and
generating an instance of an interaction experience of the first interaction experience model defined in processor-executable instructions by accessing the at least one non-transitory processor-readable storage medium;
generating one or more visual elements of the visual interaction experience; and
executing the interaction experience model defined in processor-executable instructions to cause a visual display device having a display screen to display the instance of the interaction experience of the first interaction experience model and the one or more visual elements as part of the interaction experience.

20. The method of claim 19 further comprising performing a portion of the measurements or operations relating to items or the first user using at least one sensor, and generating, by the at least one processor, the first interaction experience model at least in part using the measurements.

21. (canceled)

22. The method of claim 19 wherein the interaction experience comprises at least one of a visual interaction experience, an audio interaction experience, and a tactile interaction experience.

23. (canceled)

24. The method of claim 19 wherein the interaction experience comprises a fit surrogate interaction experience model, the method further comprising:
identifying one or more shared physical characteristics associated with a first affiliate and the first user;
identifying one or more shared gender identities associated with a first affiliate and the first user; and
generating the fit surrogate interaction experience model using the shared one or more physical characteristics, the one or more shared gender identities, and affiliate data associated with the first affiliate.

25. (canceled)

26. The method of claim 25 further comprising:
generating, by the at least one processor, the first community identifier based on one or more of:
an activity,
a location,
a device type,
a social network record,
a second community identifier,
a first affiliate identifier associated with the first user, or
a second affiliate identifier associated with one or more further affiliates
linking, by the at least one processor, a first community identifier associated with the first interaction experience model.

27. The method of claim 19 further comprising:
generating, by the at least one processor, a link to access a server providing a first interaction experience based on the first interaction experience model,
distributing, by the at least one processor, the link to access the server providing the first interaction experience based on the first interaction experience model.

28. (canceled)

29. The method of claim 27, further comprising:
distributing, by the at least one processor, the link to access the server providing the first interaction experience based on the first interaction experience model to a second user device associated with the second user in communication with the at least one processor.

30. The method of claim 27, wherein:
the plurality of items includes a respective item; and
the method further comprising generating, by the at least one processor, the link to access the server providing the first interaction experience based on the first interaction experience model, wherein the link features the respective item.

31. The method of claim 19 further comprising:
receiving, by the at least one processor from the first user device, an interaction experience customization selected by the first user; and
generating, by the at least one processor, a second interaction experience model based on the plurality of items and the set of customization selected by the first user,
wherein the interaction experience customization selected by the first user; is selected from the group comprising: item customization, esthetic customization, behavior customization, assistance customization, and rewards customization.

32. (canceled)

33. The method of claim 19 wherein:
the template for the interaction experience defines a boutique-type retail experience and defines a set of items for approval by the first user based on criteria comprising one or more of a quality level, item type, an activity associated with one or more items, aesthetic, or material composition of a good.

34. The method of claim 19, wherein the interaction experience is a retail experience, and the plurality of items are goods and services for sale from a merchant.

35. (canceled)

36. The method of claim 19, further comprising receiving one or more of affiliate data, user data, community data, and retail data, and updating the interaction experience model using the one or more of affiliate data, user data, community data, and retail data.

37-86. (canceled)

87. The system of claim 1 wherein the template for the interaction experience defines a boutique-type retail experience and defines a set of items for approval by the first user based on criteria comprising one or more of a quality level, item type, an activity associated with one or more items, aesthetic, or material composition of a good.
